(19) United States
(12) Patent Application Publication
(10) Pub. No.: US 2024/0349328 A1
(43) Pub. Date: Oct. 17, 2024

(54) COMMUNICATION SCHEDULING IN A NETWORK BASED ON DIFFERENT QOS

(71) Applicant: Charter Communications Operating, LLC, St. Louis, MO (US)

(72) Inventors: Maulik V. Vaidya, Escondido, CA (US); Nima Namvar, Charlotte, NC (US)

(21) Appl. No.: 18/439,817

(22) Filed: Feb. 13, 2024

Related U.S. Application Data
(60) Provisional application No. 63/459,255, filed on Apr. 13, 2023.

(51) Int. Cl. H04W 72/566; H04W 72/12; H04W 74/0808

(52) U.S. Cl. CPC H04W 72/566; H04W 72/12; H04W 74/0808

(57) ABSTRACT

A first wireless station implements a listen before talk function to communicate over a wireless channel to a second wireless station. The first wireless station includes a corresponding communication management resource to manage multiple access classes. For example, the communication management resource receives multiple data packets destined for delivery over the wireless channel to the second wireless station. The communication management resource detects that a first data packet and a second data packet of the multiple data packets fall in a first access class of multiple access classes. Further, the communication management resource detects that the first data packet is marked as being higher in priority than the second data packet in the first access class. In such an instance, the communication management resource schedules the first data packet for transmission over the wireless channel prior to transmission of the second data packet over the wireless channel.

### RELATED APPLICATION

This application claims the benefit of earlier filed U.S. Provisional Patent Application Ser. No. 63/459,255 entitled “COMMUNICATION SCHEDULING IN A NETWORK BASED ON QUALITY OF SERVICE,” Attorney Docket No. CHTR-2023-63P, filed on Apr. 13, 2023, the entire teachings of which are incorporated herein by this reference.

### BACKGROUND

Wi-Fi™ technology implements so-called transmit opportunities (TXOP) in which a wireless station is able to transmit data after acquiring use of a wireless channel. For example, a transmit opportunity (a.k.a., TXOP) is a MAC (Media Access Control) layer feature used in IEEE 802.11-based wireless local area network (WLAN). A TXOP defines the time duration for which a station can send frames after it has acquired rights in the wireless channel the implementation of a listen before talk function (also known as Clear Channel Assessment).

Via the TXOP time period, conventional implementation of TXOPs aim to increase the throughput of high priority data such as voice and video. According to EDCA (Enhanced Distributed Channel Access), conventional wireless stations support prioritized transmission of different types of data packets.

### BRIEF DESCRIPTION OF EXAMPLES

This disclosure includes the observation that clear channel assessment wireless technology (a.k.a., listen before talk technology) and corresponding conventional prioritization of transmitting different types of data packets suffer from deficiencies. For example, one shortcoming of Wi-Fi™ technology is the conventional implementation of wirelessly communicating data packets of different priority levels from a first wireless station to a second wireless station based on EDCA.

More specifically, prior to the introduction of QoS in Wi-Fi™ (802.11), all wireless STAs and APs operated with a single queue for both UL and DL traffic, which offered no traffic granularity. Additionally, the advent of QoS introduced 4 queues (voice, video, background, and best effort) for APs and STAs. However, legacy devices at the time lacked QoS functionality and thus continued to use a single queue for their traffic, designated under the best effort category. In such an instance, the QoS APs continued to store all the traffic for the legacy devices in the best effort queue, irrespective of the traffic type. This was a necessary evolution to enhance the Wi-Fi™ system.

As further discussed herein, this disclosure includes multiple techniques to provide better use of wireless services supporting clear channel assessment.

### Example #1

In accordance with one example, a network environment includes a first wireless station implementing a listen before talk function to communicate over a wireless channel to a second wireless station. A communication management resource of the first wireless station receives multiple data packets destined for delivery over the wireless channel to the second wireless station. The communication management resource of the first wireless station detects that a first data packet and a second data packet of the multiple data packets fall in a first access class of multiple access classes. The communication management resource of the first wireless station also detects that the first data packet is marked as being higher in priority than the second data packet in the first access class. In accordance with the priority ranking associated with the first data packet in the second data packet, the communication management resource of the first wireless station schedules the first data packet for transmission over the wireless channel prior to transmission of the second data packet over the wireless channel.

In one example, in furtherance of transmitting the data packets, the communication management resource of the first wireless station maps an identity of the first access class to a first clear channel assessment window assigned to the first access class. In response to detecting non-use of the wireless channel for a time duration as specified by the first clear channel assessment window, the communication management resource transmits the first data packet over the wireless channel followed by transmission of the second data packet over the wireless channel. In other words, since the first data packet is deemed to be higher in priority for transmission over the wireless channel, the communication management resource transmits the first data packet over the wireless channel prior to transmitting the second data packet over the wireless channel.

Note that the communication management resource of the first wireless station can be configured to transmit the first data packet over the wireless channel in response to a first acquisition (such as via a first TXOP) of the wireless channel; and transmit the second data packet over the wireless channel in response to a second acquisition (such as via a second TXOP) of the first wireless channel. Alternatively, the communication management resource can be configured to transmit the first data packet followed by the second pack data packet in response to a single acquisition (such as one TXOP) of the wireless channel via clear channel assessment (listen before talk).

In accordance with still further examples, the communication management resource can be configured to detect that the first data packet is marked as being higher in priority than the second data packet in the first access class in any suitable manner. For example, based on analyzing first bit information in the first data packet, the communication management resource detects that the first data packet is marked as a high priority data packet in the first access class; and based on analyzing second bit information in the second data packet, the communication management resource detects that the second data packet is not marked as a high priority data packet in the first access class.

In accordance with still further examples, scheduling of the first data packet for transmission over the wireless channel prior to transmission of the second data packet over the wireless channel includes the communication management resource storing the first data packet in a first queue (or first sub-queue) of the first access class and storing the second data packet in a second queue (second sub-queue) of the first access class. As further discussed herein, the communication management resource can be configured to store a third data packet in the first queue prior to storing the first data packet in the first queue. In accordance with the scheduling via storage of data packets in the queues, the communication management resource transmits the third data packet over the wireless channel followed by transmission of the first data packet over the wireless channel before transmitting the second data packet over the wireless channel. As a further example, the communication management resource can be configured to, in accordance with the scheduling: emptying the first queue by transmitting all data packets in the first queue including the first data packet over the wireless channel before transmitting the second data packet over the wireless channel.

The determination in which of the multiple cues or corresponding access classes the received data packets will be stored can be achieved in any suitable manner. In one example, the communication management resource implements a first processing layer (of a multilayer protocol stack) to detect that the first data packet is marked as being higher in priority than the second data packet in the first access class. In other words, the first processing layer can be configured to detect that the first data packet includes a respective marker indicating that it is a high priority data packet. The first processing layer can be configured to detect that the second data packet is not marked as a high priority data packet. The first processing layer can be configured to control which of multiple queues associated with the first access class each of the first data packet and the second data packet is stored for subsequent transmission over the wireless channel. For example, in response to detecting that the first data packet (via processing of respective bit information in the first data packet) is marked with a tag indicating high priority data packet, the first processing layer provides notification to store the first data packet in the higher priority queue of the first access class queue. Additionally, in response to detecting that the second data packet is not marked with a tag indicating a high priority data packet (via processing of respective bit information in the second data packet), the first processing layer provides notification to store the second data packet in the lower priority queue of the first access class queue.

In accordance with still further examples, the multiple data packets received by the communication management resource of the first wireless station further include a third data packet and a fourth data packet. The communication management resource of the first wireless station detects that the third data packet and the fourth data packet of the multiple data packets fall into (such as based on a type of data conveyed by the third data packet and the fourth data packet) a second access class of the multiple access classes. Assume that the second access class is higher priority than the first access class. In such an instance, the communication management resource of the first wireless station schedules the third data packet and the fourth data packet for transmission over the wireless channel prior to transmission of the first data packet and/or the second data packet over the wireless channel.

As further discussed herein, scheduling of the third data packet and the fourth data packet for transmission over the wireless channel prior to transmission of the first data packet over the wireless channel may include the communication management resource storing the third data packet and the fourth data packet in a first queue of the second access class and subsequently transmitting the third data packet and the fourth data packet over the wireless channel prior to transmitting the first data packet over the wireless channel.

Alternatively, scheduling of the third data packet and the fourth data packet for transmission over the wireless channel prior to transmission of the first data packet over the wireless channel may include the communication management resource of the first wireless station: i) storing the third data packet in a first queue of the second access class; ii) storing the fourth data packet in a second queue of the second access class; and iii) transmitting the third data packet and the fourth data packet over the wireless channel prior to transmitting the first data packet and the second data packet over the wireless channel.

### Example #2

In accordance with one example, a network environment includes a first wireless station implementing a listen before talk function to communicate over a wireless channel to a second wireless station. A communication management resource of the first wireless station receives multiple data packets destined for delivery over the wireless channel to the second wireless station. Each of the multiple data packets assigned one of multiple scheduling priority levels. The communication management resource uses mapping information to schedule the multiple data packets for transmission over the wireless channel. The mapping information provides a one-to-one mapping such as between UP (User Priority) and AC (Access Classes) from which the multiple data packets are scheduled for transmission from the first wireless station to the second wireless station.

In yet further examples, depending on the scheduling priority levels assigned to the access class queues and corresponding data packets, the communication management resource transmits the multiple data packets from the first wireless station over the wireless channel to the second wireless station. For example, the communication management resource can be configured to implement any number of access class queues, each of which is assigned a different duration contention window to access the wireless channel and transmit the data packets. In one example, after storing the data packets in each of the different queues, in furtherance of transmitting the data packets over the wireless channel, the communication management resource of the first wireless station maps an identity of a first access class queue to a first clear channel assessment window assigned to the first access class queue. In response to detecting non-use of the wireless channel for a time duration as specified by the first clear channel assessment window, the communication management resource: i) retrieves a first data packet from the first access class queue, and ii) transmits the first data packet over the wireless channel to the second wireless station.

In further examples, the communication management resource implements a first processing layer in a multi-layer protocol stack to process each of the multiple data packets via the mapping information. The first processing layer is implemented between a MAC (Media Access Control) processing layer and an application processing layer in a multi-layer protocol stack to select in which of the access class queues to store each of the multiple data packets.

Still further, implementation the mapping information providing the one-to-one mapping of scheduling priority levels to access class queues may include: mapping of a first per hop behavior value (such as indicating first user priority) associated with a first data packet to a first access class queue of the access class queues; and a second per hop behavior value (such as indicating second user priority) to a second access class queue of the access class queues.

Yet further, using the mapping information to schedule the multiple data packets for transmission over the wireless channel can be configured to include: obtaining a first priority level value from a first data packet of the multiple data packets, the first priority level value being a layer 3 bit marking of the first data packet; in response to detecting the first priority level value in the first data packet, storing the first data packet in a first access class queue assigned to the first priority level value; obtaining a second priority level value from a second data packet of the multiple data packets, the second priority level value being a layer 3 bit marking of the second data packet; and in response to detecting the second priority level value in the second data packet, storing the second data packet in a second access class queue assigned to the second priority level value. In accordance with scheduling priority levels assigned to the access class queues, transmitting the first data packet and the second data packet from the first wireless station over the wireless channel to the second wireless station.

Note that the layer 3 bit marking and corresponding value of the first data packet may be a first DSCP (Differentiated Service Code Point) marking of the first data packet; and the layer 3 bit marking of the second data packet may be a second DSCP (Differentiated Service Code Point) marking of the second data packet, and so on.

In a similar manner as previously discussed, using the mapping information to schedule the multiple data packets may include: storing a first data packet of the multiple data packets in a first sub-queue of the first access class queue of the access class queues in response to: i) detecting that the first data packet is assigned a first priority level value associated with the first access class queue, and ii) detecting presence of a supplemental priority marker in the first data packet; and storing a second data packet of the multiple data packets in a second sub-queue of the first access class queue in response to: i) detecting that the second data packet is assigned the first priority level value associated with the first access class queue, and ii) detecting absence of the supplemental priority marker in the second data packet.

In accordance with priority levels of the access class queues, the communication management resource as discussed herein can be configured to transmit the first data packet from the first wireless station over the wireless channel to the second wireless station followed by transmitting the second data packet from the first wireless station over the wireless channel to the second wireless station. Using the mapping information to schedule the multiple data packets may include: storing a third data packet of the multiple data packets in a first sub-queue of a second access class queue of the access class queues in response to: i) detecting that the third data packet is marked with a second priority level value associated with the second access class queue, and ii) detecting presence of a supplemental priority marker in the first data packet; and storing a fourth data packet of the multiple data packets in a second sub-queue of the second access class queue in response to: i) detecting that the fourth data packet is assigned the second priority level value associated with the first access class queue, and ii) detecting absence of the supplemental priority marker in the fourth data packet.

### Example #3

In accordance with another example, a network environment includes a first wireless station and a second wireless station, each implementing a listen before talk function to communicate over a wireless channel. Thus, the wireless channel is acquirable via a listen before talk access function. As further discussed herein, the first wireless station can be configured to transmit first communications from the first wireless station. The first communications can be configured to indicate that the first wireless station supports customization of data delivery classes supporting conveyance of wireless communications in accordance with a listen-before-talk access function (such as implemented by Wi-Fi™ or any other suitable wireless communication protocol). In other words, the first wireless station such as a wireless access point or a mobile communication device can be configured to support a default set of access classes and corresponding data delivery queues to communicate data packets over the wireless channel to the first wireless station. If the second wireless station (such as a wireless access point or mobile communication device) supports customization of the data delivery queues as an alternative to using the default data delivery queues, the first wireless station can be configured to implement use the alternative data delivery queues for the delivery of the data packets to the first wireless station. For example, the first wireless station further receives second communications from a second wireless station in response to the second wireless station receiving the first communications. The second communications indicate that the second wireless station supports the customization of the data delivery classes. Accordingly, each of the first wireless station in the second wireless station are aware that they both support the customization of the data delivery classes.

Note that the first communications and the second communications may be conveyed between the first wireless station and the second wireless station during association of the second wireless station with the first wireless station. The subsequent communications conveyed over the wireless channel can be implemented via the customized data delivery queues instead of default data delivery queues.

In one example, the second communications received from the second wireless station include a message to implement an auxiliary set (a.k.a., customized set) of data delivery queues instead of a default set of data delivery queues for third communications (such as the data packets destined for delivery to the second wireless station) transmitted from the first wireless station to the second wireless station. Note that the first wireless station or second wireless station can select how many different access classes and corresponding data delivery queues are to be used in the customized implementation of data delivery queues.

In a similar manner as previously discussed, the first wireless station transmitting the corresponding data packets of the second wireless station can be configured to implement a first processing layer in a multi-layer protocol stack implementing multiple processing layers to process each of the received data packets destined for the second wireless station. Note that the first processing layer storing the received packets into the different queues may be any processing layer between a MAC processing layer and an application processing layer in the multi-layer protocol stack, inclusive of the MAC processing layer and the application processing layer.

Yet further, subsequent to receiving the second communications such as approval from the second wireless station to implement a customized set of access classes and corresponding data delivery queues, the first wireless station establishes a first (custom) configuration of the data delivery classes for use by the first wireless station to control transmission of data packets wirelessly communicated from the first wireless station to the second wireless station.

Note that establishing the custom data delivery classes and corresponding custom data delivery queues may include the first wireless station transmitting a configuration message to the second wireless station. The configuration message can be configured to indicate attributes of the data delivery classes as specified by the first configuration of data delivery queues established by the first wireless station. Accordingly, the second wireless station can be notified of how to set up similar data delivery queues of the first configuration at the second wireless station for communication of data packets from the second wireless station to the first wireless station. In other words, either or both of the first wireless station in the second wireless station can be configured to support the customization of access classes and corresponding data delivery queues.

In a still further example, the first configuration of the data delivery classes and corresponding data delivery queues as implemented by the first wireless station is a substitute to a default set of data delivery classes and corresponding queues supported by the first wireless station to communicate in a downlink direction from the first wireless station to the second wireless station and a third wireless station. In other words, the first wireless station can be configured to support the default set of data delivery classes and corresponding queues to communicate with one or more communication devices in the downlink direction. In response to receiving the second communications from the second wireless station, the first wireless station sets up a first configuration of data delivery classes and corresponding data delivery queues for communication of data packets from the first wireless station to the second wireless station. In such an instance, the second wireless station receives the benefit of the first wireless station implementing the first configuration of the data delivery classes instead of having to use the default set of data delivery classes and corresponding queues to communicate with the second wireless station. In a reverse direction, in response to receiving communications from the first wireless station, the second wireless station sets up a custom configuration of data delivery classes and corresponding data delivery queues for communication of data packets from the second wireless station to the first wireless station.

In accordance with another example as discussed herein, subsequent to setting up the first configuration of data delivery classes and corresponding data delivery queues as an alternative to the default data delivery queues, the first wireless station receives multiple data packets destined for delivery over a wireless channel to the second wireless station. As previously discussed, the wireless channel used by the first wireless station to transmit data packets is acquirable via the listen-before-talk function. The first wireless station and corresponding communication management resource schedule the multiple data packets for transmission over the wireless channel in accordance with the first configuration (such as a customized implementation of the data delivery classes, which is an alternative to the default data delivery queues).

In a reverse direction, subsequent to setting up the custom configuration of data delivery classes and corresponding data delivery queues as an alternative to the default data delivery queues, the second wireless station receives multiple data packets destined for delivery over a wireless channel to the first wireless station. As previously discussed, the wireless channel used by the first wireless station to transmit data packets is acquirable via the listen-before-talk function. The second wireless station and corresponding communication management resource schedule the multiple data packets for transmission over the wireless channel in accordance with the custom configuration of queues (such as a customized implementation of the data delivery classes, which is an alternative to the default data delivery queues).

In yet a further example, the first configuration of the data delivery classes and corresponding queues (such as customized set of queues for the second wireless station) may include X different data delivery classes, where X is an integer value. As previously discussed, both the first wireless station and the second wireless station can be configured to at least initially support conveyance of data packets in accordance with a default set of data delivery classes and corresponding queues. In one example, the first wireless station and the second wireless station implement Y data delivery classes as a default setting prior to implementing the customized X data delivery classes, where Y is an integer value. The benefit of the first wireless station and/or the second wireless station electing use of the customized set of data delivery classes and corresponding data delivery queues instead of the default set is that the customized set include a greater number of data delivery classes and corresponding data delivery queues than the default set (X). In other words, in one example, the integer value X may be greater than the integer value Y.

As further discussed herein, the first wireless station and a second wireless station may be initially configured to implement a first data delivery class configuration (such as default) of prioritizing a flow of conveying messages from the first wireless station to the second wireless station over the wireless channel. In response to receiving the second communications from the second wireless station, the first wireless station implements a second customized data delivery class configuration and corresponding data delivery queues to convey multiple data packets destined for delivery from the first wireless station to the second wireless station or vice versa. As previously discussed, the second data delivery class configuration (customized configuration) may be different than the first default data delivery class configuration.

Another example of the communication system as discussed herein includes a wireless station and corresponding communication management resource performing operations of: establishing at least one data delivery queue for each of the multiple data delivery classes supporting the conveyance of the wireless communications from the first wireless station to the second wireless station; receiving multiple data packets destined for delivery to the second wireless station; and storing a corresponding data packet of the multiple data packets in a respective data delivery queue of the multiple data delivery queues depending on a priority level determined for the corresponding data packet; detecting a first data packet stored in a first data delivery queue of the multiple data delivery queues; obtaining a first contention window value associated with the first data delivery queue; and in response to detecting that wireless energy detected in the wireless channel is below a wireless energy threshold level for a time duration as specified by the first contention window, wirelessly transmitting the first data packet over the wireless channel from one wireless station to another wireless station.

Note that any of the resources as discussed herein can include one or more computerized devices, communication management resources, mobile communication devices, servers, base stations, wireless communication equipment, communication management systems, controllers, workstations, user equipment, handheld or laptop computers, or the like to carry out and/or support any or all of the method operations disclosed herein. In other words, one or more computerized devices or processors can be programmed and/or configured to operate as explained herein to carry out the different examples as described herein.

Yet other examples herein include software programs to perform the steps and operations summarized above and disclosed in detail below. One such example comprises a computer program product including computer readable storage hardware (such as hardware to store executable instructions), non-transitory computer-readable storage media, etc., on which software instructions are encoded for subsequent execution. The instructions, when executed in a computerized device (hardware) having a processor, program and/or cause the processor (hardware) to perform the operations disclosed herein. Such arrangements are typically provided as software, code, instructions, and/or other data (e.g., data structures) arranged or encoded on a non-transitory computer readable storage hardware medium such as an optical medium (e.g., CD-ROM), floppy disk, hard disk, memory stick, memory device, etc., or other a medium such as firmware in one or more ROM, RAM, PROM, etc., or as an Application Specific Integrated Circuit (ASIC), etc. The software or firmware or other such configurations can be installed on a computerized device to cause the computerized device to perform the techniques explained herein.

Accordingly, examples herein are directed to a method, system, computer program product, etc., that supports operations as discussed herein.

One example includes a computer readable storage medium and/or system having instructions stored thereon to facilitate better use of available wireless resources. The instructions, when executed by computer processor hardware, cause the computer processor hardware (such as one or more co-located or disparately processor devices or hardware) to: receive multiple data packets destined for delivery from a first wireless station over a wireless channel to a second wireless station, the wireless channel acquirable via a listen before talk function (such as clear channel assessment function); detect that a first data packet and a second data packet of the multiple data packets fall in a first access class of multiple access classes; detect that the first data packet is marked as being higher in priority than the second data packet in the first access class; and schedule the first data packet for transmission over the wireless channel prior to transmission of the second data packet over the wireless channel.

One example includes a computer readable storage medium and/or system having instructions stored thereon to facilitate better use of available wireless resources. The instructions, when executed by computer processor hardware, cause the computer processor hardware (such as one or more co-located or disparately processor devices or hardware) to: receive multiple data packets destined for delivery over a wireless channel to a second wireless station, the wireless channel acquirable via a listen before talk function, each of the multiple data packets assigned one of multiple scheduling priority levels; and use mapping information to schedule the multiple data packets for transmission over the wireless channel, the mapping information providing a one-to-one mapping of scheduling priority levels to access class queues from which the multiple data packets are scheduled for transmission from the first wireless station to the second wireless station.

One example includes a computer readable storage medium and/or system having instructions stored thereon to facilitate better use of available wireless resources. The instructions, when executed by computer processor hardware, cause the computer processor hardware (such as one or more co-located or disparately processor devices or hardware) to: transmit first communications from the first wireless station, the first communications indicating that the first wireless station supports customization of data delivery classes associated with conveyance of wireless communications via a listen-before-talk access function; and receive second communications from a second wireless station in response to the second wireless station receiving the first communications, the second communications indicating that the second wireless station supports the customization of the data delivery classes.

Note that the ordering of the steps above has been added for clarity sake. Further note that any of the processing steps as discussed herein can be performed in any suitable order.

Other examples of the present disclosure include software programs and/or respective hardware to perform any of the method example steps and operations summarized above and disclosed in detail below.

It is to be understood that the system, method, apparatus, instructions on computer readable storage media, etc., as discussed herein also can be embodied strictly as a software program, firmware, as a hybrid of software, hardware and/or firmware, or as hardware alone such as within a processor (hardware or software), or within an operating system or a within a software application.

As discussed herein, techniques herein are well suited for use in the field of providing wireless communication services. However, it should be noted that examples herein are not limited to use in such applications and that the techniques discussed herein are well suited for other applications as well.

Additionally, note that although each of the different features, techniques, configurations, etc., herein may be discussed in different places of this disclosure, it is intended, where suitable, that each of the concepts can optionally be executed independently of each other or in combination with each other. Accordingly, the one or more present inventions as described herein can be embodied and viewed in many different ways.

Also, note that this preliminary discussion of examples herein (BRIEF DESCRIPTION OF EXAMPLES) purposefully does not specify every example and/or incrementally novel aspect of the present disclosure or claimed invention(s). Instead, this brief description only presents general examples and corresponding points of novelty over conventional techniques. For additional details and/or possible perspectives (permutations) of the invention(s), the reader is directed to the Detailed Description section (which is a summary of examples) and corresponding figures of the present disclosure as further discussed below.

### BRIEF DESCRIPTION OF THE DRAWINGS

FIG. 1 is an example diagram illustrating a network environment and multiple wireless stations communicating with each other over one or more wireless communication links (via one or more wireless channels) as discussed herein.

FIG. 2 is an example diagram illustrating reception and queuing of multiple data packets for transmission over a wireless channel from a first wireless station to a second wireless station as discussed herein.

FIG. 3 is an example diagram illustrating reception and queuing of multiple data packets for transmission over a wireless channel from a first wireless station to a second wireless station as discussed herein.

FIG. 4 is an example diagram illustrating user priority information and mapping to access class queues as discussed herein.

FIG. 5 is an example diagram illustrating reception and queuing of multiple data packets for transmission over a wireless channel from a first wireless station to a second wireless station as discussed herein.

FIG. 6 is an example diagram illustrating configuration of one or more wireless stations to support a substitute (custom) access class queue configuration instead of default access class queue configuration as discussed herein.

FIG. 7 is an example diagram illustrating flow of communications supporting customization of data delivery classes amongst multiple wireless stations as discussed herein.

FIG. 8 is an example diagram illustrating a configuration management frame supporting customization of data delivery classes as discussed herein.

FIG. 9 is an example diagram of a wireless access point implementing custom access class queues and default access class queues to communicate with multiple communication devices in a network environment as discussed herein.

FIG. 10 is an example diagram illustrating a mobile communication device configured to communicate wireless communications in accordance with custom access class queue as discussed herein.

FIG. 11 is an example diagram illustrating example computer architecture operable to execute one or more operations as discussed herein.

FIG. 12 is an example diagram illustrating a method as discussed herein.

FIG. 13 is an example diagram illustrating a method as discussed herein.

FIG. 14 is an example diagram illustrating a method as discussed herein.

FIG. 15 is an example diagram illustrating a method as discussed herein.

The foregoing and other objects, features, and advantages of the invention will be apparent from the following more particular description of preferred examples herein, as illustrated in the accompanying drawings in which like reference characters refer to the same parts throughout the different views. The drawings are not necessarily to scale, with emphasis instead being placed upon illustrating the examples, principles, concepts, etc.

### DETAILED DESCRIPTION

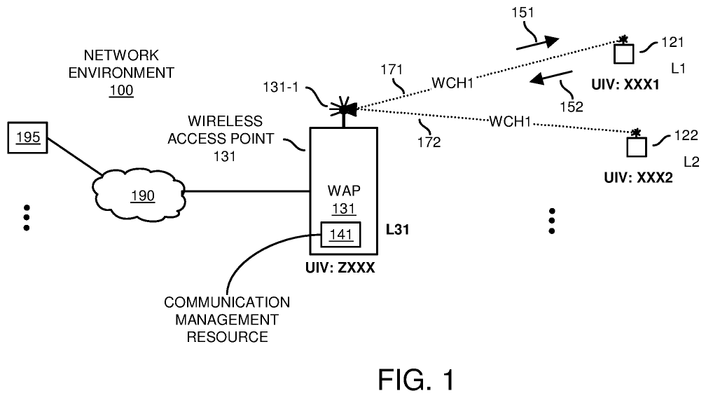

Now, more specifically, with reference to the drawings, FIG. 1 is an example diagram illustrating a network environment and multiple wireless stations communicating with each other over a wireless communication link (wireless channel) as discussed herein.

As shown, network environment 100 includes server resource 195, network 190, wireless access point 131 (i.e., a wireless station), and one or more instances of user equipment such as mobile communication device 121 (i.e., a wireless station), mobile communication device 122, etc.

Network environment 100 includes any number of wireless access points and any number of corresponding mobile communication devices.

As further shown, wireless network environment 100 or wireless access point 131 further includes communication management resource 141. The communication management resource 141 and the wireless access point 131 may be co-located or disparately located.

Note that the communication management resource 141 can be configured to execute operations or any of the functionality as described herein associated with the wireless access point 131 (such as a first wireless station).

Note further that each of the resources in network environment 100 can be configured to include or be configured as appropriate hardware, software, or combination of hardware and software to carry out respective operations as discussed herein.

For example, the communication management resource 141 as described herein can be implemented via respective communication management hardware, communication management software, or a combination of communication management hardware and communication management software; the wireless access point 131 as described herein can be implemented via respective wireless access point hardware, wireless access point software, or a combination of wireless access point hardware and wireless access point software; communication device 121 can be implemented via communication device hardware, communication device software, or a combination of communication device hardware and communication device software; and so on.

Further in this example, each of the wireless stations is assigned a respective unique identifier value (such as network address for routing purposes) supporting communication of wireless messages. For example, wireless access point 131 (wireless station) at location L31 is assigned unique identifier value ZXXX; communication device 121 at location L1 is assigned unique identifier value XXX1; communication device 122 at location L2 is assigned unique identifier value XXX2; and so on.

As further shown, each of the wireless access points such as including wireless access point 131 in network environment 100 includes respective one or more instances of antenna hardware to wirelessly communicate directly with mobile communication devices (a.k.a., user equipment).

For example, the wireless access point 131 includes one or more instances of antenna hardware 131-1 (such as one or more antenna elements). Note that different sets of the antenna elements associated with the antenna hardware 131-1 can be configured to support different beamforming to transmit first wireless communications and receive second wireless communications in the network environment 100.

The wireless stations such as mobile communication device 121, mobile communication device 122 wireless access point 131, etc., support any of one or more wireless communications (or wireless communication protocols such as Wi-Fi™ or other suitable protocol) in one or more wireless frequency bands (unlicensed or licensed bands) such as 2.4 GHz (2.4 to 2.5 GHz), 5 GHz (5.1 to 5.9 GHz), and/or 6 GHz (5.9 to 7.1 GHz). Further in this example, the wireless access point 131 implements antenna hardware 131-1 to transmit wireless signals 151 to the mobile communication device 121 at location L1. The wireless access point 131 implements antenna hardware 131-1 to receive wireless signals 152 from the mobile communication device 121.

Yet further in this example, the wireless access point 131 and mobile communication device 121 establish wireless communication link 171 between the wireless access point 131 and the mobile communication device 121. Via wireless communications 151, the wireless access point 131 communicates messages (such as one or more data packets) over wireless channel WCH1 in the downlink direction to the mobile communication device 121. Further, the mobile communication device 121 transmits wireless communications 152 over the wireless channel WCH1 in the uplink direction to the wireless access point 131.

Thus, via the communications 151 and communications 152, the wireless access point 131 provides the mobile communication device 121 access to the remote network 190 and any of one or more server resources 195. As its name suggests, note further that the mobile communication device 121 (a.k.a., wireless station) can be configured to move around the network environment 100.

Still further, note that each of the wireless stations (wireless access point 131, mobile communication device 121, etc.) in the network environment 100 can be configured to implement a respective clear channel assessment function (a.k.a., listen before talk access function) prior to transmitting communications in the network environment 100.

For example, the wireless access point 131 can be configured to implement a listen before talk function (clear channel assessment function) in which the wireless access point 131 needs to acquire the wireless channel WCH1 before it is allowed to communicate the communications 151 in the downlink direction to the mobile communication device 121. Acquisition of the wireless channel WCH1 (such as a detected energy of the wireless channel below a threshold level for a time duration of a contention window) by the wireless access point 131 may include the wireless access point 131 detecting that a power level of wireless signals transmitted in the wireless channel WCH1 or corresponding wireless channel of interest is below a threshold level for a listen before talk time duration. If the detected wireless power level is greater than a threshold level for the listen before talk time duration, the wireless access point 131 waits until a respective next time slot or time to listen again to acquire the wireless channel WCH1.

In a similar manner, the mobile communication device 121 can be configured to implement a listen before talk function (clear channel assessment function) in which the mobile communication device 121 needs to acquire the wireless channel WCH1 before it is allowed to communicate the communications 152 in the uplink direction to the wireless access point 131. Acquisition of the wireless channel WCH1 by the mobile communication device 121 may include the mobile communication device 121 detecting that a power level of wireless signals transmitted in the wireless channel WCH1 or corresponding wireless channel of interest is below a threshold level for a listen before talk time duration. If the detected wireless power level is greater than a threshold level for the listen before talk time duration, the wireless station 121 waits until a respective next time slot or time to listen again to acquire the wireless channel WCH1.

Thus, each of the wireless stations in the network environment 100 can be configured to implement a respective clear channel assessment prior to transmitting communications in the network environment 100.

In a similar manner, each of multiple wireless stations (such as wireless access points, wireless base station, mobile communication devices, etc.) in the network by 100 can be configured to implement listen before talk functions to acquire a respective wireless channels transmit corresponding wireless communications.

As further discussed below, the communication management resource 141 can be configured to implement one or more access class queues (and corresponding sub-queues in each access class) to control delivery of data packets over the wireless communication link 171. All of the processing operations as discussed herein with respect to the communication management resource 141 can be implemented in the mobile communication device 121 as well.

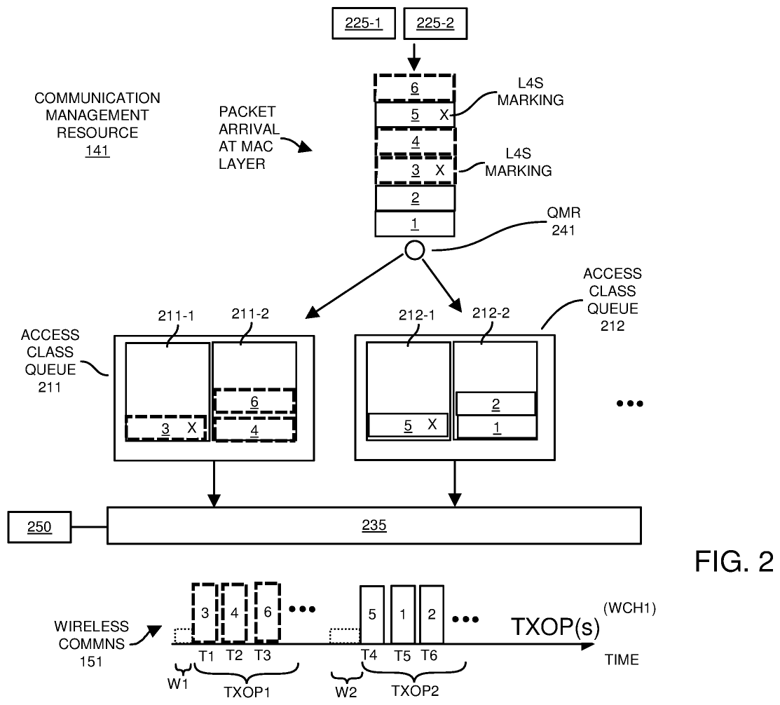

FIG. 2 is an example diagram illustrating reception in queuing of multiple data packets for transmission over a wireless channel from a first wireless station to a second wireless station as discussed herein.

In this example, the applications 225 (one or more different applications such as application 225-1 such as a voice processing application, application 225-2 such as a video processing application, and so on) generates data packets for transmission to the mobile communication device 121.

Each of the data packets (such as data packet #3, data packet #4, and data packet #6, etc.) generated by the application 225-1 or other suitable entity can be configured to include a source network address of ZXXX assigned to the wireless access point 131 and a destination address of XXX1.

Each of the data packets (such as data packet #1, data packet #2, and data packet #5, etc.) generated by the application 225-2 or other suitable entity can be configured to include a source network address of ZXXX assigned to the wireless access point 131 and a destination address of XXX1.

No further that the data packet stored in the corresponding access class queues 211, 212, etc., can be transmitted to multiple different mobile communication devices. For example, in one example, the data packets 3, 5, and 1 can be transmitted by the wireless access point 131 to the mobile communication device 121; the data packets 4, 6, and 2 can be transmitted by the wireless access point 131 to the mobile communication device 122. Alternatively, all of the data packets 1-6 can be transmitted to the mobile communication device 121. Accordingly, the access class queues as discussed herein can be used to communicate both data packets to multiple different mobile communication devices.

In this example, assume that the application 225-1 or other suitable entity generates the data packet #3, data packet #4, and data packet #6. Assume that the application 225-2 or other suitable entity generates the data packet #1, data packet #2, data packet #5, and so on.

As further discussed below, any processing layer in the multi-layer protocol stack (or one or more of applications 225) can be configured to mark the data packets with a L4S marker (denoted by letter X). This provides notification to the queue management resource 241 that the marked data packets are given special higher priority for a particular access class queue (a.k.a., data delivery queue) to which the data packet and corresponding data payload pertain.

In other words, the access class queue 211 has a higher priority than the access class queue 212 for transmitting respective data packets to one or more destination wireless stations. Within the access class queue 211, the sub queue 211-1 is assigned a higher priority for transmission of those data packets than the data packets in the sub queue 211-2. Within the access class queue 212, the sub queue 212-1 is assigned a higher priority for transmission of those data packets than the data packets in the sub queue 212-2.

As further shown, the communication management resource 141 includes queue management resource 241 to manage storage of the data packets in appropriate queues as they are received depending on a respective access class (a.k.a., data delivery class) to which each of the data packets belong. Note that the communication management resource 241 as discussed her can include any number of access class queues (a.k.a., data delivery queues) and corresponding access class sub-queues (a.k.a., data delivery sub-queues).

For example, assume that the data packet #3, data packet #4, and the data packet #6 include a first type of data (such as critical voice data associated with application 225-1) and therefore belong to a first access class assigned access class queue 211. Note that the access class queue 211 can be configured to include sub-queue 211-1 and sub-queue 211-2.

Assume that the data packet #1, the data packet #2, data packet #5, etc., include a second type of data (such as video data associated with application 225-2) and therefore belong to a second access class assigned access class queue 212. Note that the access class queue 212 can be configured to include sub-queue 212-1 and sub-queue 212-2.

Based on processing of bit information such as indicating a type of data conveyed in each of the received data packets (such as 1, 2, 3, 4, 5, 6, etc.), in accordance with the priorities associated with each of the access class queues, the queue management resource 241 stores the received data packets into the different access classes and corresponding access class queues 211, 212, etc.

For example, the queue management resource 241 (such as at the MAC processing layer or higher processing layer in a multilayer wireless communication protocol) determines that the data packet #1 includes video data associated with the access class queue 212. Because there is no high-priority marker (unique bit value as indicated by letter X) in the data packet #1 for that access class, the queue management resource 241 stores the data packet #1 in the low priority sub-queue 212-2 of access class queue 212.

The queue management resource 241 determines that the data packet #2 includes video data associated with the access class queue 212. Because there is no high-priority marker (unique bit value as indicated by letter X) in the data packet #2 for that access class, the queue management resource 241 stores the data packet #2 in the low priority sub-queue 212-2 of access class queue 212.

The queue management resource 241 determines that the data packet #3 includes voice data (highest priority) associated with the access class queue 211. Because there is a high-priority marker (unique bit value as indicated by letter X) in the data packet #3 for that access class, the queue management resource 241 stores the data packet #3 in the high-priority sub-queue 211-1 of access class queue 211.

The queue management resource 241 determines that the data packet #4 includes voice data associated with the access class queue 211. Based on the determined priority associated with data packet #4, the queue management resource 241 stores the data packet #4 in the access class queue 211. Because there is no high-priority marker in the data packet #4 for that access class, the queue management resource 241 stores the data packet #4 in the sub-queue 211-2 of access class queue 211.

The queue management resource 241 determines that the data packet #5 includes video data (second highest priority type of data) associated with the access class queue 212. Because there is a high-priority marker x in the data packet #5 for that access class, the queue management resource 241 stores the data packet #5 in the high-priority sub-queue 212-1 of access class queue 212. In the access class queue 212, as previously discussed, the sub-queue 212-1 stores higher priority data packets than the sub-queue 212-2.

The queue management resource 241 determines that the data packet #6 includes voice data associated with the access class queue 211. Because there is no high-priority marker x in the data packet #6 for that access class, the queue management resource 241 stores the data packet #6 in the low priority sub-queue 211-2 of access class queue 211.

As previously discussed, any of the multiple processing layers as received from upper layers in the protocol stack can be configured to mark data packets with an x which are treated appropriately by MAC layer (such as, access class scheduler such as queue management resource 241, data packet scheduling geographical region 235, etc.) to queue for wireless transmission in respective access queues. In certain instances, the upper processing layers may not tag data packets with an L4S marking (such as indicated by the letter X). The L4S marking indicates that the corresponding data packet should be transmitted in accordance with low latency. However, note that the access point 131 itself or other suitable entity such as communication management resource 141, data packet scheduling manager 235, queue management resource 241, etc., may detect congestion associated with one or more of the access class queues such as due to internal factors (e.g., queue fill-ups, queue full condition, or external factors such as upstream routers of the wireless access point 131 experience congestion, and so on). In such case(s) of congestion, the wireless access point 131 and any of the corresponding management entities as previously discussed can be configured to tag any newly received data packets with L4S marking despite the fact that the queue management resource 241 did not receive the data packets with such marking from an upper processing layer(s). In other words, the data packet #3 and data packet #5 may initially include the L4S marking. Note that any of the data packets such as data packet #1, data packet #2, data packet #4, data packet #6, etc., can be marked with the L4S marking if desired even though the queue management resource 241 did not receive those data packets with such markings.

The proactive novel marking of the newly received data packets allows for providing better transmission of the data packets over the respective wireless channel WCH1. In accordance with the transmission rules 250, the scheduler 235 retrieves the data packets from the different queues for transmission over the wireless communication link and corresponding wireless channel WCH1.

Note that the rules 250 can include any suitable information such as a respective contention window size that is to be used to communicate respective one or more data packet stored in each of the access class queues, restrictions on which data packets from which queues can be transmitted in a same respective channel acquisition timeframe (TXOP), priority associated with transmission of the data packets in each of the queues, how many data packets in a first queue can be transmitted before transmitting data packets from a next queue, and so on.

In one example, via the rules 250, it is desirable to provide fairness of transmitting data packets from each of the queues over the wireless channel WCH1 for each of the applications 225 such that each of the respective applications generating the corresponding data type (such as different priority levels of voice data, different priority levels of video data, different priority levels of background data, different priority levels of best effort data, etc.) is able to communicate respective data packets to a desired target recipient.

Note that the data packets stored in the different queues do not need to be transmitted to the same wireless station. Instead, the destination network address in each of the data packets in the access class queue 211 may be a first mobile communication device, the destination network address in each of the data packets in the access class queue 212 may be a second mobile communication device, and so on.

Alternatively, any of the data packets in the access class queue 211 can be destined for delivery to any of multiple mobile communication devices; any of the data packet to the access class queue 212 can be destined for delivery to any of multiple mobile communication devices; and so on.

As previously discussed, in accordance with the rules 250, the different access class queues are afforded a different priority of transmitting respective data packets over the wireless communication link and corresponding wireless channel WCH1. For example, the access class queue 211 can be configured to store highest priority data for transmission over the wireless channel WCH1; the access class queue 212 can be configured to store a second highest priority data for transmission over the wireless channel WCH1; and so on.

As further discussed herein, the data packet scheduling manager 235 retrieves the data packets from the different access class queues for transmission over the wireless communication link upon acquiring a first active wireless channel WCH1 (via one or more TXOPs).

For example, via a listen before talk function, the data packet scheduling manager 235 monitors the wireless channel WCH1 for availability using a first contention window W1 associated with the access class queue 211. Via a listen before talk function, the data packet scheduling manager 235 monitors the wireless channel WCH1 for availability using a second contention window W2 associated with the access class queue 212.

Note that the assigned contention window W1 associated with access class queue 211 (which has a higher priority than the access class queue 212) may be shorter than a time duration of the assigned contention window W2 associated with the access class queue 212. The ensures that the access class queue 211 is afforded a higher priority of transmitting data over the wireless channel (i.e., WCH1) in the access class queue 212. However, note that the data packet scheduling manager 235 can be configured to transmit any or all of the data packets in the access class queues on acquisition (such as TXOP1 or TXOP2) or the same TXOP of the wireless channel WCH1 depending on the rules 250. For example, the rules 250 may allow the data packet scheduling manager 235 to acquire the wireless channel WCH1 via implementation of the contention window W1 to transmit data packets in the access class queue 211 for the corresponding acquired channel for the duration TXOPL. If any left over time duration associated with the acquired wireless channel TXOP1 is available, the data packet scheduling manager resource 235 may also transmit data packets #1, #2, #5 in the same channel acquisition such as TXOP1 can be used to transmit one or more of data packets 3, 4, and 6.

Alternatively, the data packet scheduling manager 235 may be required to acquire the wireless channel WCH1 multiple different times during multiple contention windows to acquire the wireless channel at multiple different times to transmit the data packets in each of the different access class queues.

For example, assume that the data packet scheduling manager 235 acquires the wireless channel at or around time T1 in response to detecting that the wireless energy associated with the wireless channel WCH1 as detected by the wireless access point 131 is less than a threshold level for the window W1. In such an instance, the data packet scheduling manager 235 detects that the highest priority access class queue 211 includes data packets in both sub queue 211-1 and sub queue 211-2. Because the sub queue 211-1 stores higher priority data packets than sub-queue 211-2, the data packet scheduling manager 235 first transmits the data packet #3 over the wireless channel WCH1 at or around time T1 followed by transmission of the data packet #4 at or around time T2 and transmission of the data packet #6 at or around time T3.

In a same or different channel acquisition such as TXOP1 or TXOP2, the data packet scheduling manager 235 uses the wireless channel WCH1 at or around time T4 to transmit a data packet #5. In such an instance, the data packet scheduling manager 235 detects that the second highest priority access class queue 212 includes data packets in both sub queue 212-1 and sub queue 212-2. Because the sub queue 212-1 stores higher priority data packets than sub-queue 212-2, the data packet scheduling manager 235 transmits the data packet #5 over the wireless channel WCH1 at or around time T4 followed by transmission of the data packet #1 at or around time T5 and transmission of the data packet #2 at or around time T6.

In the case of acquiring the wireless channel WCH1 multiple times, the scheduling management resource 235 implements the first contention window W1 associated with the first access class queue 211 because the scheduling management resource 235 detects presence of data packets in the access class queue 211 for transmission over the wireless communication link 171 to the communication device 121. In response to the wireless access point 131 detecting that the wireless energy level at the antenna hardware 131-1 is less than an energy level threshold level for a duration of the window W1 assigned to the access class queue 211, the scheduling management resource 235 acquires the wireless channel WCH1 for the channel acquisition time TXOP1 and transmits the corresponding data packets #3, #4, #6 at respective times T1, T2, T3, in that acquisition time TXOP1.

Further, in the case of acquiring the wireless channel WCH1 multiple times, the scheduling management resource 235 implements the contention window W2 associated with the second access class queue 212 because the scheduling management resource 235 detects presence of data packets in the access class queue 212 for transmission over the wireless communication link 171 to the communication device 121. In response to the wireless access point 131 detecting that the wireless energy level at the antenna hardware 131-1 is less than an energy level threshold level for a duration of the window W2 assigned to the second access class queue 212, the scheduling management resource 235 acquires the wireless channel WCH1 for the channel acquisition time TXOP2 and transmits the corresponding data packets #5, #1, #2, at respective times T4, T5, T6, in that acquisition time TXOP2.

Thus, in accordance with one example, a network environment as discussed herein includes a first wireless station (131) implementing a listen before talk function to communicate over a wireless channel to a second wireless station (121). A communication management resource 141 of the first wireless station receives multiple data packets destined for delivery over the wireless channel WCH1 to the mobile communication device 121. The communication management resource 141 of the first wireless station detects that a first data packet (such as data packet #3) and a second data packet (such as data packet #4) of the multiple data packets fall in a first access class queue 211 of multiple access classes. The communication management resource 140 of the first wireless station (131) also detects that the first data packet (data packet #3) is marked as being higher in priority than the second data packet (data packet #4) in the first access class. In accordance with the priority ranking associated with the queues and corresponding data packet #3 and the second data packet #4, the communication management resource 141 of the first wireless station schedules the data packet #3 for transmission over the wireless channel WCH1 prior to transmission of the data packet #4 over the wireless channel WCH1.

In one example, in furtherance of transmitting the data packets, the communication management resource of the first wireless station such as wireless access point 131 and corresponding communication management resource 141 implementing the schedule management resource 235 can be configured to map an identity of the first access class to a first clear channel assessment window value (contention window W1) assigned to the first access class 211 to acquire the wireless channel WCH1 at or around or just prior to time T1. In response to detecting non-use of the wireless channel for a time duration as specified by the first clear channel assessment window (W1) assigned to the first access class associated with access class queue 211, the communication management resource transmits the first data packet (#3) over the wireless channel WCH1 (and wireless communication link 171) followed by transmission of the second data packet (#4) over the wireless channel the WCH1 and wireless communication link 171. In other words, as previously discussed, since the data packet #3 is deemed to be higher in priority for transmission over the wireless channel WCH1 than the data packet #4, the communication management resource 141 transmits the data packet #3 over the wireless channel WCH1 prior to transmitting the data packet #4 over the wireless channel WCH1.

Further, as previously discussed, the communication management resource 141 and corresponding data packet scheduling manager 235 of the first wireless station (131) can be configured to transmit any of the data packets #3, #4, and #6 over the wireless channel WCH1 in response to a first acquisition (such as via a first TXOP1) of the wireless channel WCH1 via implementation of the first Clear Channel assessment window W1 (such as a first listen before talk window); and transmit one or more of the data packets #5, #1, #2 over the wireless channel WCH1 in response to a second acquisition of the wireless channel WCH1 using a second contention window (W2) associated with the second access class queue 212.

In other words, the data packet scheduling manager 235 can be configured to implement the first contention window W1. In response to detecting nonuse of the wireless channel WCH1 such as wireless energy in the wireless channel WCH1 below a respective energy threshold level or the duration of the first contention window W1, the scheduling manager 235 transmits at least the data packets #3, #4, #6. If extra time is available in the TXOP1 for that channel acquisition, the scheduling manager 235 can be configured to also transmit data packets #5, #1, #2, in that same acquisition time TXOP1.

In another example, the data packet scheduling manager 235 can be configured to implement the first contention window W1 to acquire the wireless channel WCH1 and transmit data packets from the axis class queue 211. In response to detecting nonuse of the wireless channel WCH1 such as wireless energy in the wireless channel WCH1 below a respective energy threshold level or the duration of the first contention window W1, the scheduling manager 235 transmits at least the data packets #3, #4, #6 over the acquired wireless channel WCH1 in the acquired TXOP1 for the first contention window W1. After losing or completion of using the channel WCH1 after the window TXOP1, the data packet scheduling manager 235 can be configured to implement the second contention window W2 to acquire the wireless channel WCH1 again. In response to detecting nonuse of the wireless channel WCH1 at the antenna hardware 131-1 such as wireless energy in the wireless channel WCH1 below a respective energy threshold level for the duration of the second contention window W2, the scheduling manager 235 acquires the wireless channel WCH1 just prior to time T4 and transmits at least the data packets #5, #1, and #2 in that acquired TXOP2 (time of acquiring wireless channel WCH1 again) for the second contention window W2.

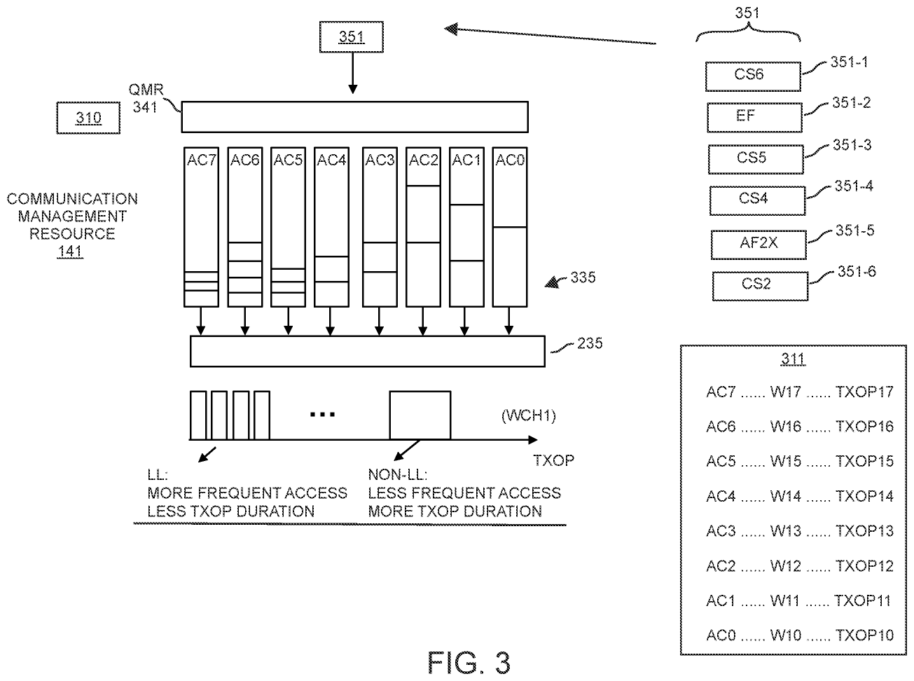

FIG. 3 is an example diagram illustrating reception and queuing of multiple data packets for transmission over a wireless channel from a first wireless station to a second wireless station as discussed herein.

Note that examples herein include potentially increasing the number of access classes for improved traffic management in a system implementing clear channel assessment (listen before talk). For example, the conventional standard of access class configuration defines 4 different access classes, each having different priority level and contention window size. However, this may not be enough to handle the increasing diversity of traffic types of wireless data packets transmitted in the respective wireless network.

As previously discussed, the number of access classes may be determined via the user priority information and thus the maximum number of access classes can be any number of classes. Extending the range for user priority information from four default access class configuration to a substitute custom access class configuration as discussed herein may require some modification on the higher layers to support the assignment of the data packets to the different classes.

As further discussed herein, implementation of a one-to-one mapping between the user priority information and queue selection implemented at the application layer or other layer above the MAC layer in the multilayer protocol stack as implemented by the communication management resource 141 and implementing a greater number of access classes and corresponding queues allows for better classification of the traffic. However, the proposed expansion requires an increased number of classes such as classes 0 through 7 (such as a total of 8 classes or other suitable value), each of which is a assigned a respective appropriate contention window size and inter-frame spacing settings.

In this example, from highest priority to lowest priority, or for most priority to highest priority, the access class queues 335 include access class queue AC7, access class queue AC6, access class queue AC5, access class queue AC4, access class queue AC3, access class AC2, access class AC1, and access class AC0. That is

The additional access classes such as 8 access classes (and corresponding 8 access class queues AC7-AC0) instead of 4 access classes allows for optimized inter-frame spacing and contention window sizing to accommodate the different priority levels associated with the traffic. In other words, the conventional techniques of implementing only 4 different access classes and corresponding queues is very limiting. The techniques as discussed herein improve access class queuing and transmission of data in a listen before talk system supporting conveyance of communications between wireless stations.

In accordance with one example, as previously discussed, a network environment as shown in FIG. 1 includes a first wireless station (such as wireless access point 131) implementing a listen before talk function to communicate over a wireless channel WCH1 to a second wireless station such as the mobile communication device 121.

As shown in FIG. 3, In this example, the communication management resource 141 in or associated with the wireless access point 131 includes the queue management resource 341, mapping information 310, access class queues 335, and scheduler management resource 235, and so on.

Assume that the communication management resource 141 receives the data packets 351 including the data packet 351-1 marked with the access class value CS6, the data packet 351-2 marked with the access class value EF, data packet 351-3 marked with the access class value CS5, data packet 351-4 marked with the axis class value CS4, data packet 351-5 marked with the axis class value AF2X, data packet 351-6 marked with the access class value CS2, and so on. The access class values in this example indicate which of multiple access class queues the corresponding data packets 351 are to be stored. In other words, the axis class values indicate a respective priority associated with communication of those respective data packets over the wireless channel to the target communication device.

In general, in this example, the queue management resource 341 receives the corresponding data packets 351. The queue management resource 341 uses the mapping information 310 as a basis in which to store each of the different data packets into an appropriate one of the queues 335. In other words, the communication management resource 341 (also known as queue management resource) of the first wireless station such as the wireless access point 131 receives multiple data packets 351 destined for delivery over the wireless channel WCH1 to the second wireless station such as the communication device 121.

In this example, each of the multiple data packets 351 is assigned one of multiple scheduling priority levels such as access class markings including the access class value CS6, access class value EF, access class value CS5, access class value CS4, and so on. In one example, the access class values as discussed herein are marked at the layer 3. Thus, via layer 3 processing of each of the data packets 351, the queue management resource 341 can be configured to determine which of the multiple classes each of the received data packets 351 should be stored for subsequent transmission over the wireless communication link 171.

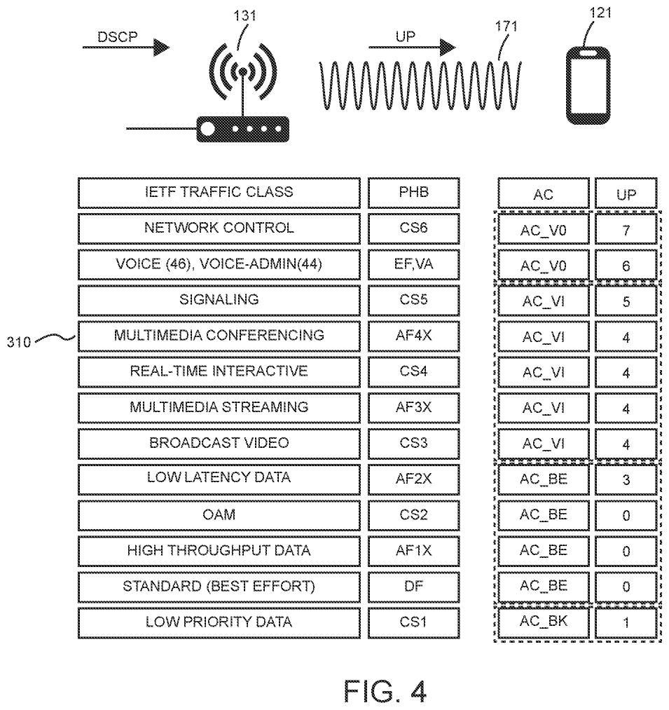

The communication management resource 341 uses mapping information 310 to schedule the multiple data packets 351 for transmission over the wireless channel WCH1. In one example, as shown in FIG. 4, the mapping information 310 provides a one-to-one mapping of scheduling priority levels (associated with the received data packets) to access class queues AC7-AC0 from which the multiple data packets are scheduled for transmission from the wireless access point 131 to the mobile communication device 121.

In yet further examples, depending on the scheduling priority levels assigned to the access class queues and corresponding data packets 351, the communication management resource 141 transmits the multiple data packets 351 from the wireless access point 131 over the wireless channel WCH1 to the mobile communication device 121. For example, the communication management resource associated with the wireless access point 131 can be configured to implement any number of access class queues, each of which is assigned a different duration contention window to access the wireless channel and transmit the data packets.

In this example, the queue management resource 341 receives the data packet 351-1. Via layer 3 or other type of processing, the queue management resource 341 determines that the data packet 351-1 is marked with the respective access class value CS6. Via the mapping information 310, the queue management resource 341 determines that the access class value CS6 maps to access class queue AC7 (highest priority queue). In such an instance, the queue management resource stores the data packet 351-1 in the access class queue AC7.

Further, the queue management resource 341 receives the data packet 351-2. Via layer 3 or other type of processing, the queue management resource 341 determines that the data packet 351-2 is marked with the respective access class value EF. Via the mapping information 310, the queue management resource 341 determines that the access class value EF maps to access class queue AC6. In such an instance, the queue management resource stores the data packet 351-2 in the access class queue AC6.

The queue management resource 341 receives the data packet 351-3. Via layer 3 or other type of processing, the queue management resource 341 determines that the data packet 351-3 is marked with the respective access class value CS5. Via the mapping information 310, the queue management resource 341 determines that the access class value CS5 maps to access class queue AC5. In such an instance, the queue management resource stores the data packet 351-3 in the access class queue AC5.

The queue management resource 341 receives the data packet 351-4. Via layer 3 or other type of processing, the queue management resource 341 determines that the data packet 351-4 is marked with the respective access class value CS4. Via the mapping information 310, the queue management resource 341 determines that the access class value CS4 maps to access class queue AC4. In such an instance, the queue management resource stores the data packet 351-4 in the access class queue AC4.

The queue management resource 341 receives the data packet 351-5. Via layer 3 or other type of processing, the queue management resource 341 determines that the data packet 351-5 is marked with the respective access class value AF2X. Via the mapping information 310, the queue management resource 341 determines that the access class value AF2X maps to access class queue AC3. In such an instance, the queue management resource stores the data packet 351-5 in the access class queue AC3.

The queue management resource 341 receives the data packet 351-6. Via layer 3 or other type of processing, the queue management resource 341 determines that the data packet 351-6 is marked with the respective access class value CS2. Via the mapping information 310, the queue management resource 341 determines that the access class value CS2 maps to access class queue AC2. In such an instance, the queue management resource stores the data packet 351-6 in the access class queue AC2.

In a similar manner, the queue management resource 341 stores multiple data packets with the same access class value in the corresponding access class queue.

In one example, after storing the data packets in each of the different queues as previously discussed, scheduling management resource 235 detects that the access class queue AC7 includes data packets for transmission to the mobile communication device 121. In furtherance of transmitting the data packets in the access class queue AC7 over the wireless channel WCH1, via the configuration information 311, the communication management resource 141 of the wireless access point 131 maps an identity of access class queue AC7 to a clear channel assessment window size (W17) and corresponding time duration (TXOP17) assigned to the first access class queue AC7. In response to detecting non-use of the wireless channel for a time duration as specified by the clear channel assessment window W17 (such as wireless energy detected by the antenna hardware 131-1 below a threshold level for the time duration W17 to acquire the wireless channel WCH1 for a corresponding time duration TXOP17), the communication management resource 141: acquires the wireless channel WCH1 for a duration TXOP17; retrieves each of the data packets stored in the access class queue AC7 including data packet 351-1 from the first access class queue (such as AC7); and during the time duration TXOP17 associated with the acquired channel, transmits one or more of the data packets retrieved from the access class queue AC7 (highest priority queue) over the wireless channel WCH1 via communication link 171 to the mobile communication device 121.

After storing the data packets in each of the different queues, scheduling management resource 235 detects that the access class queue AC6 includes data packets for transmission to the mobile communication device 121. In furtherance of transmitting the data packets over the wireless channel WCH1, via the configuration information 311, the communication management resource 141 of the wireless access point 131 maps an identity of a access class queue AC6 to a clear channel assessment window duration (W16) and corresponding time duration (TXOP17) assigned to the access class queue AC6. In response to detecting non-use of the wireless channel for a time duration as specified by the clear channel assessment window W16 (such as wireless energy detected by the antenna hardware 131-1 below a threshold level for the time duration W16 to acquire the wireless channel WCH1 for a corresponding time duration TXOP16), the communication management resource 141: acquires the wireless channel WCH1 for the time duration TXOP16; retrieves each of the data packets stored in the access class queue AC6 including data packet 351-2 from the access class queue (such as AC6); and during the acquired channel time duration TXOP16, transmits one or more of the data packets retrieved from the access class queue AC6 over the wireless channel WCH1 via communication link 171 to the mobile communication device 121.

After storing the data packets in each of the different queues, scheduling management resource 235 detects that the access class queue AC5 includes data packets for transmission to the mobile communication device 121. In furtherance of transmitting the data packets over the wireless channel WCH1, via the configuration information 311, the communication management resource 141 of the wireless access point 131 maps an identity of a access class queue AC5 to a clear channel assessment window duration (W15) and corresponding time duration (TXOP15) assigned to the access class queue AC5. In response to detecting non-use of the wireless channel for a time duration as specified by the clear channel assessment window W15 (such as wireless energy detected by the antenna hardware 131-1 below a threshold level for the time duration W15 to acquire the wireless channel WCH1 for a corresponding time duration TXOP15), the communication management resource 141: acquires the wireless channel WCH1 for time duration TXOP15; retrieves each of the data packets stored in the access class queue AC5 including data packet 351-3 from the access class queue (such as AC5); and during the acquired channel time duration TXOP15, transmits one or more of the data packets retrieved from the access class queue AC5 over the wireless channel WCH1 via communication link 171 to the mobile communication device 121.

After storing the data packets in each of the different queues, scheduling management resource 235 detects that the access class queue AC4 includes data packets for transmission to the mobile communication device 121. In furtherance of transmitting the data packets over the wireless channel WCH1, via the configuration information 311, the communication management resource 141 of the wireless access point 131 maps an identity of a access class queue AC4 to a clear channel assessment window duration (W14) and corresponding time duration (TXOP14) assigned to the access class queue AC4. In response to detecting non-use of the wireless channel for a time duration as specified by the clear channel assessment window W14 (such as wireless energy detected by the antenna hardware 131-1 below a threshold level for the time duration W14 to acquire the wireless channel WCH1 for a corresponding time duration TXOP14), the communication management resource 141: acquires the wireless channel WCH1; retrieves each of the data packets stored in the access class queue AC4 including data packet 351-4 from the access class queue (such as AC4); and during the acquired channel time duration TXOP14, transmits one or more of the data packets retrieved from the access class queue AC4 over the wireless channel WCH1 via communication link 171 to the mobile communication device 121.

In a similar manner, the scheduling management resource 235 associated with the communication management resource 141 transmits data packets 351 from each of the queues over the wireless communication link 171 via the wireless channel WCH1.

In further examples, the communication management resource implements queue management resource 341 at a first processing layer (such as layer 3 or other suitable data packet processing layer) in a multi-layer protocol stack to process each of the multiple data packets via the mapping information 310. The first processing layer may be implemented at any layer between a MAC (Media Access Control) processing layer and an application processing layer in a multi-layer protocol stack of communicating the data packets 351 to select in which of the access class queues AC7-AC0 to store each of the multiple data packets 351.

Still further, in accordance with the mapping information 310 in FIG. 4, implementation the mapping information 310 providing the one-to-one mapping of scheduling priority levels to access class queues may include: mapping of a first per hop behavior value (such as access class value CS6 indicating first user priority) associated with a first data packet 351-1 to a first access class queue AC7 of the access class queues; mapping of a second per hop behavior value (such as access class value EF indicating a second user priority) associated with a data packet 351-2 to an access class queue AC6 of the access class queues; mapping of a third per hop behavior value (such as access class value CS5 indicating a third user priority) associated with a data packet 351-3 to an access class queue AC5 of the access class queues; and so on.

Accordingly, implementation of the mapping information 310 to schedule the multiple data packets for transmission over the wireless channel may include the queue management resource 341: obtaining a first priority level value (such as access class value) from a first data packet of the multiple data packets, the first priority level value being a layer 3 bit marking of the first data packet; in response to detecting the first priority level value in the first data packet, storing the first data packet in a first access class queue assigned to the first priority level value; obtaining a second priority level value (such as a second access class value) from a second data packet of the multiple data packets, the second priority level value being a layer 3 bit marking of the second data packet; and in response to detecting the second priority level value in the second data packet, storing the second data packet in a second access class queue assigned to the second priority level value.

In other words, as previously discussed, a marking (such as CS6, EF, CS5, CS4, etc.) in each of the respective data packets indicate which of the multiple queues to store the respective data packet. Data packets marked with the value CS6 are stored in the access class queue AC7; data packets marked with the value EF are stored in the access class queue AC6; data packets marked with the value CS5 are stored in the access class queue AC5; so on

In accordance with scheduling priority levels assigned to the access class queues, the communication management resource transmits the first data packet and the second data packet from the first wireless station (wireless access point 131) over the wireless channel WCH1 and wireless communication link 171 to the communication device 121.

Note that the layer 3 bit marking (such as access class values CS6, EF, CS5, etc., as previously discussed or other suitable information) and corresponding value of the first data packet may be a first DSCP (Differentiated Service Code Point) marking of the first data packet; and the layer 3 bit marking of the second data packet may be a second DSCP (Differentiated Service Code Point) marking of the second data packet, and so on.

FIG. 4 is an example diagram illustrating user priority information and mapping to access class queues as discussed herein.

In this example, as previously discussed, the mapping information 310 indicates a mapping of IETF traffic class information and per hop behavior values to corresponding user priority information for transmitting data packets. Each user priority value and/or corresponding per hop behavior value may map to a single access class queue in a manner as previously discussed.

As shown in FIG. 4, there are 12 IETF traffic (data packet) types that are mapped to only 8 UPs (User Priorities) and the UPs are further down sampled/mapped to 4 access classes. The concept of one to one mapping is introduced between access class AC and UP as previously discussed in FIG. 3.

For example, the network control information assigned per hop behavior value CS6 maps to user priority 7 (highest priority) and thus access class queue AC7.

The voice data class assigned per hop behavior value EF, VA maps to user priority 6 and thus access class queue AC6.

The signaling class assigned per hop behavior value CS5 maps to user priority 5 and access class queue AC5.

The multimedia conferencing class assigned per hop behavior value AF4x maps to user priority 4 and access class queue AC4.

The real-time interactive class assigned per hop behavior value CS4 maps to user priority 4 and access class queue AC4.

The multimedia streaming class assigned per hop behavior value AF3x maps to user priority 4 and access class queue AC4.

The low latency data class assigned per hop behavior value AF2x maps to low user priority level 3 and corresponding access class queue AC3.

The OAM class assigned per hop behavior value CS2 maps to user priority level 0 and corresponding access class queue AC0, and so on.

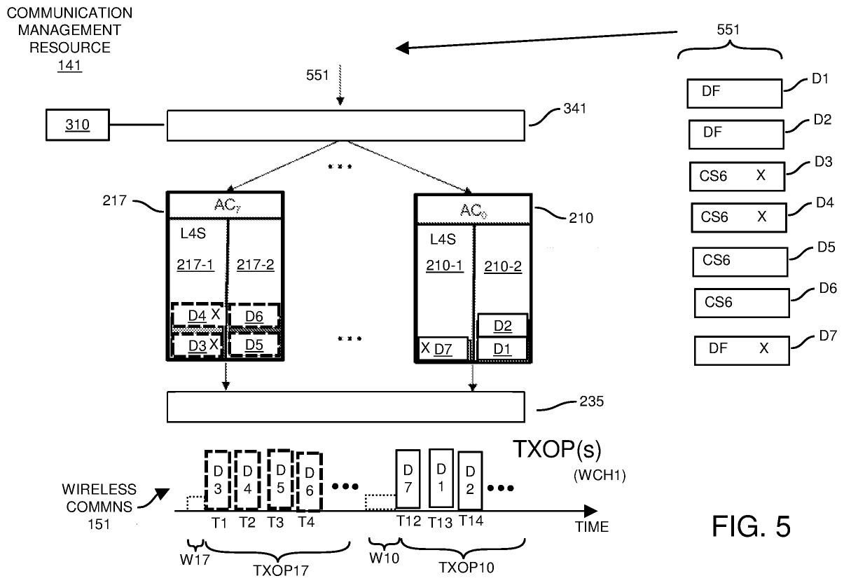

FIG. 5 is an example diagram illustrating reception and queuing of multiple data packets for transmission over a wireless channel from a first wireless station to a second wireless station as discussed herein.

In this example, each of the access class queues in FIG. 5 includes a primary sub queue and a secondary sub queue. The primary sub queue associated with a respective access class stores data packets for the access class having a low latency marker X for low latency data packets. The secondary sub queue associated with the respective access class stores data packets that do not have a respective low latency marker X for high latency data packets. Thus, in a manner as previously discussed, the different sub queues within a respective priority queue or access class may have a higher priority sub queue and a low priority sub queue.

More specifically, the queue management resource 341 receives the data packets 551 including data packet D1, data packet D2, data packet D3, data packet D4, data packet D5, data packet D6, and data packet D7.

In this example, each of the data packets includes a respective access class value in a data field of the respective data packet. For example, each of the data packets D1, D2, and D7, include or are marked with the corresponding access class value DF; each of the data packets D3, D4, D5 and D6, include or are marked with the corresponding access class value CS6.

Each of the data packets D3, D4, and D7 are marked with the low latency marker X. This means that such data packets marked with the low latency marker X are given higher priority in the corresponding access class than those data packets that are not marked with the corresponding latency marker X.

Each access class in this example includes a first sub queue and a second sub queue to store the low latency and high latency mark data packets.

For example, the access class queue AC7 (217) includes the low latency sub queue 217-1 to store low latency marked data packets and the high latency sub queue 217-2 to store non-low latency marked data packets associated with the access queue 217. The access class queue AC0 (210) includes the low latency sub queue 210-1 to store low latency marked data packets and the high latency sub queue 210-2 to store non-marked data packets associated with the access queue 210.

As further shown, the queue management resource 341 associated with the communication management resource 141 (of the wireless access point 131) receives the data packet D1. The queue management resource 341 determines that the received data packet D1 is marked with the access class identifier value DF and is not marked with the low latency marker X. Via the mapping information 310, the queue management resource 341 determines that the data packet D1 marked with the access class value DF and not marked with the low latency marker X is to be stored in the sub queue 210-2 associated with the access class queue AC0. In such an instance, the queue management resource 341 stores the data packet D1 in the sub queue 210-2.

The queue management resource 341 associated with the communication management resource 141 (of the wireless access point 131) receives the data packet D2. The queue management resource 341 determines that the received data packet D2 is marked with the access class identifier value DF and is not marked with the low latency marker X. Via the mapping information 310, the queue management resource 341 determines that the data packet D2 marked with the access class value DF and not marked with the low latency marker X is to be stored in the sub queue 210-2 associated with the access class queue AC0. In such an instance, the queue management resource 341 stores the data packet D2 in the sub queue 210-2.

The queue management resource 341 associated with the communication management resource 141 (of the wireless access point 131) receives the data packet D3. The queue management resource 341 determines that the received data packet D3 is marked with the access class identifier value CS6 and is marked with the low latency marker X. Via the mapping information 310, the queue management resource 341 determines that the data packet D3 marked with the access class value CS6 and marked with the low latency marker X is to be stored in the sub queue 217-1 associated with the access class queue AC7. In such an instance, the queue management resource 341 stores the data packet D3 in the sub queue 217-1.

The queue management resource 341 associated with the communication management resource 141 (of the wireless access point 131) receives the data packet D4. The queue management resource 341 determines that the received data packet D4 is marked with the access class identifier value CS6 and is marked with the low latency marker X. Via the mapping information 310, the queue management resource 341 determines that the data packet D4 marked with the access class value CS6 and marked with the low latency marker X is to be stored in the sub queue 217-1 associated with the access class queue AC7. In such an instance, the queue management resource 341 stores the data packet D4 in the sub queue 217-1.

The queue management resource 341 associated with the communication management resource 141 (of the wireless access point 131) receives the data packet D5. The queue management resource 341 determines that the received data packet D5 is marked with the access class identifier value CS6 and is not marked with the low latency marker X. Via the mapping information 310, the queue management resource 341 determines that the data packet D5 marked with the access class value CS6 and not marked with the low latency marker X is to be stored in the sub queue 217-2 associated with the access class queue AC7. In such an instance, the queue management resource 341 stores the data packet D5 in the sub queue 217-2.

The queue management resource 341 associated with the communication management resource 141 (of the wireless access point 131) receives the data packet D6. The queue management resource 341 determines that the received data packet D6 is marked with the access class identifier value CS6 and is not marked with the low latency marker X. Via the mapping information 310, the queue management resource 341 determines that the data packet D6 marked with the access class value CS6 and not marked with the low latency marker X is to be stored in the sub queue 217-2 associated with the access class queue AC7. In such an instance, the queue management resource 341 stores the data packet D6 in the sub queue 217-2.

The queue management resource 341 associated with the communication management resource 141 (of the wireless access point 131) receives the data packet D7. The queue management resource 341 determines that the received data packet D7 is marked with the access class identifier value DF and is marked with the low latency marker X. Via the mapping information 310, the queue management resource 341 determines that the data packet D7 marked with the access class value DF and marked with the low latency marker X is to be stored in the sub queue 210-1 associated with the access class queue AC0. In such an instance, the queue management resource 341 stores the data packet D7 in the sub queue 210-1.

Thus, using mapping information 310, the scheduler 341 stores data packet D3 in sub-queue 217-1 of the access class queue 217 in response to: i) detecting that the data packet D3 is assigned a first priority level value such as higher priority associated with the access class queue 217 (based on the marker X in the data packet D3). The scheduler 341 stores data packet D6 of the multiple data packets in sub-queue 217-2 of the access class queue 217 in response to: i) detecting that the data packet D6 is assigned the second priority level value associated with the access class queue 217 based on detecting absence of the supplemental low latency priority marker X in the data packet D6.

Thus, as shown in FIG. 5, in accordance with mapping information 310 indicating which data packets and data types to store in each queue and sub-queue, the queue management resource 341 (a.k.a., scheduler) stores the data packet #D1 in the sub-queue 210-2; the queue management resource 341 stores the data packet #D2 in the sub-queue 210-2; the queue management resource 341 stores the data packet #D3 in the sub-queue 217-1; the queue management resource 341 stores the data packet #D4 in the sub-queue 217-1; the queue management resource 341 stores the data packet #D5 in the sub-queue 217-2; the queue management resource 341 stores the data packet #D6 in the sub-queue 217-2; the queue management resource 341 stores the data packet #D7 in the sub-queue 210-1; and so on.

In a similar manner as previously discussed, the schedule manager or data packet transmission manager 235 attempts to acquire the wireless channel WCH1 via monitoring a wireless energy level associated with the wireless channel WCH1 at the antenna hardware 131-1. In response to detecting that the wireless energy level in the wireless channel WCH1 is less than a respective threshold level for the duration of the listen-before-talk time duration or contention window W17, the communication management resource 141 acquires the wireless channel WCH1 and then transmits the higher priority data packets #3, #4, #5, #6 associated with the access class queue AC7 in a corresponding time duration TXOP17.

Subsequent to the time duration TXOP17, in response to detecting that the wireless energy level in the wireless channel WCH1 is less than a respective threshold level for the duration of the listen-before-talk time duration or contention window W10, the communication management resource 141 acquires the wireless channel WCH1 and then transmits the lower priority data packets #7, #1, and #2 associated with the access class queue AC0 in a corresponding time duration TXOP10.

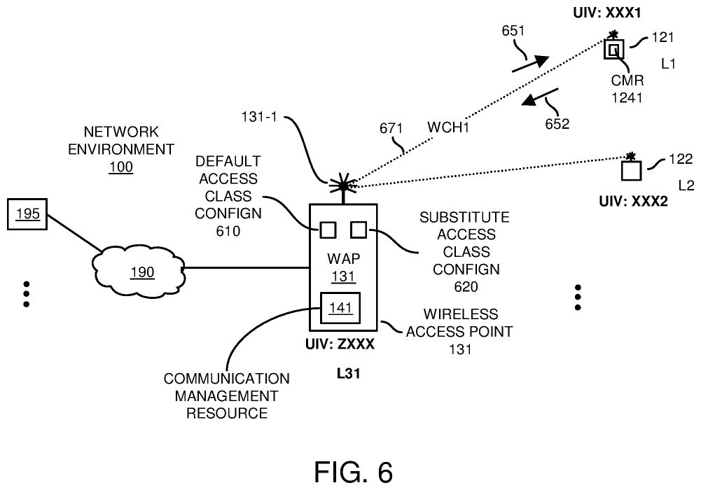

FIG. 6 is an example diagram illustrating configuration of one or more wireless stations to support a substitute access class queue configuration in addition to or as an alternative to a default access class queue configuration as discussed herein.

In this example, one or more of the wireless stations as discussed herein implement a customization mode of implementing alternative access classes and corresponding data delivery queues in which the wireless stations initially communicate (such as during association or other suitable time) with each other to indicate a capability of supporting a different or custom configuration of access class queues with respect to a default number of access class queues.

If both the wireless access point 131 and the wireless station 121 support the customization mode as discussed herein, then both the wireless access point 131 and the mobile communication device 121 can be configured to employ one or more access classes (data delivery classes) as an alternative to using default access classes and corresponding data delivery queues via use of a newly configured access class queue system.

For example, the wireless access point 131 includes the communication management resource 141 to support the custom access classes and corresponding custom access class queues; the mobile communication device 121 includes the communication management resource 1241 to support the custom access classes and corresponding custom access class queues.

In one configuration, the maximum number of the extra access classes for the custom mode may be limited to a predetermined amount. For each access class and corresponding queue associated with the custom mode, the support information and corresponding settings such as contention window size, TXOP, etc., are maintained to be between at least restrictive and most restrictive parameter of present-day access classes (a.k.a., default access classes and corresponding default data delivery queues) such that the configurations for the substitute (custom) access class configuration is fair with respect to legacy devices and the default configuration.

In other words, settings associated with the contention window size and time duration TXOP for each of the classes in the custom mode each may fall within a respective range. The settings for contention window size for any additional data delivery class in the custom mode can be configured to fall within the acceptable contention window time range for that type of access class data queue. The settings for the TXOP time duration for any additional data delivery class queue may fall within the acceptable TXOP time range for that type of data queue.

The expansion of the access classes and corresponding queues for the custom mode as discussed herein allows for optimized IFS (Inter-Frame Space) and contention window size to accommodate the low latency traffic associated with the different classes of traffic.

More specifically, as shown in FIG. 6, a network environment 100 includes a first wireless station (wireless access point 131) and a second wireless station (mobile communication device 121), each implementing a listen before talk function to communicate over a wireless channel. Thus, the wireless channel WCH1 is acquirable via a listen-before-talk function.

Based on configuration communications (such as via communications 651 and/or 652) between the wireless access point 131 and the communication device 121, the communication management resource 141 of the first wireless station (such as wireless access point 131) establishes multiple custom access classes and corresponding data delivery queues (such as associated with the substitute access class configuration 620) for use by the wireless access point 131 to control transmission of data packets from the wireless access point 131 to the communication device 121.

In other words, the wireless access point 131 can be configured to implement a default access class configuration 610 in which the wireless access point 131 supports the default number of data delivery classes (such as for classes including a first access class queue supporting voice VO, a second access class queue supporting video VI, a third access class queue supporting best effort BE, and a fourth access class queue supporting background BK data packets) to support different classes of data such as video, voice, nonvoice, etc. The substitute or custom access class configuration 620 including custom access classes and corresponding custom data delivery queues supports one or more additional or alternative access classes (data delivery classes) and corresponding queues to support a higher resolution of custom access class service.

As further discussed herein, the custom access class queues (such as associated with the substitute access class configuration 620) and default access class queues (such as associated with the default access class configuration 610) can be used to communicate with one or more communication devices supporting such different queue configurations.

Further in this example, subsequent to setting up the one or more default access classes and additional access classes, assume that the communication management resource 141 receives multiple data packets destined for delivery from the wireless access point 131 to the communication device 121. In a similar manner as previously discussed, the communication management resource 141 schedules the data packets for transmission over the wireless channel WCH1 in accordance with the multiple access classes (such as substitute access class configuration 620) and corresponding data delivery queues in a manner as specified by the configuration 610 to communicate with one or more first communication devices in the network environment 100. As discussed herein, the wireless access point 131 also can be configured to implement default access class queues associated with the default access class configuration 610 to communicate with one or more second communication devices in the network environment 100.

In accordance with further examples and selection of the custom access class configuration 620, the communication management resource of the wireless access point 131 can be configured to establish at least one queue for each of the multiple access classes in accordance with the configuration setup communications 651 and 652 and configuration 620.

As previously discussed in any of the other drawing such as FIG. 2, 3, or 6, each of the different access classes may implement multiple access class sub-queues for a given access class. Additionally, in a similar manner as previously discussed, the wireless access point 131 can be configured to store each corresponding data packet of the multiple data packets in a respective queue of the multiple queues created by the wireless access point 131 depending on a priority level determined for the corresponding data packet.

For example, assume that the communication management resource 141 detects a first data packet stored in a first queue of the multiple queues of the configuration 620 and obtains a first contention window value associated with the first queue. Via the listen before talk function, in response to detecting that wireless energy detected in the wireless channel is below a wireless energy threshold level for a time duration as specified by the first contention window, the communication management resource 141 wirelessly transmits the first data packet over the wireless channel WCH1 and corresponding wireless communication link 671 from the wireless access point 131 to the communication device 121.

As previously discussed, the configuration communications such as 651 and/or 652 supporting set up of multiple queues and priority levels (associated with the substitute access class configuration 620) can be conveyed between the wireless access point 131 and the communication device 121 during association of the communication device 121 with the wireless access point 131.

Note further that the multiple access classes (data delivery classes and corresponding queues) for the substitute access class configuration 620 implemented by one or more of the wireless access point 131 or the communication device 121 can be implemented via conveyance of configuration communications between the first wireless station (such as wireless access point 131 or communication device 121) and the second wireless station (such as communication device 121 or wireless access point 131); the configuration communications may include information such as specifying X classes, where X is an integer value indicating the number of data delivery classes and corresponding queues associated with the substitute or custom access class configuration 620.

Note that the value X may be the total number of data delivery classes and corresponding queues implemented by the wireless access point 131 and the communication device 121 or a number of extra data delivery classes respect to the default number of data delivery classes and corresponding default data delivery queues (Y) to be executed by a respective wireless station such as the wireless access point 131 and/or the communication device 121.

Note further that one or more of the wireless access point 131 and the communication device 121 may initially be configured to implement Y default access classes prior to an override with respect to default setting (such as the default access class configuration 610) prior to implementing the X custom classes associated with the substitute access class configuration 620, where Y is an integer value as well. The integer value X may be greater than the integer value Y such as 4 classes. In other words, the wireless access point 131 and the communication device 121 each initially support the default number of access class queues but may be configured to override a default setting (as specified by default access class configuration 610) of implementing default access classes and corresponding queues in favor of a higher number access classes and queues as specified by the configuration communications (and set up of custom or substitute access class configuration 620) between the first wireless station and the second wireless station.

Thus, the wireless access point 131 and the communication device 121 may be initially configured to implement a first access class configuration (610) of prioritizing a flow of conveying messages from the wireless access point 131 to the communication device 121 over the wireless channel WCH1, the first access class configuration 610 being a default access class configuration. Based on the configuration communications (651, 652) with the communication device 121, the communication management resource 141 implements a second custom access class configuration (620) and corresponding access class queues as specified by the communications to convey the multiple data packets from the wireless access point 131 (first wireless station) to the communication device 121 (second wireless station). Thus, the second access class configuration 620 is different than the first access class configuration 610.

In accordance with further examples, note that the communications 651 from the wireless access point 131 to the communication device 121 can be configured to include contention window information indicating a respective magnitude of a contention window assigned to each of the multiple access classes associated with the customized access class configuration.

Still further, in a similar manner as previously discussed, a communication management resource 141 of the wireless access point 131 can be configured to implement a first processing layer in a multi-layer protocol stack to process each of multiple received data packets destined for delivery over the wireless channel WCH1 to the mobile communication device 121 over the wireless communication link 671 using the wireless channel WCH1. The first processing layer of storing the received data packets in different data delivery queues may reside between a MAC processing layer and an application processing layer in the multi-layer protocol stack. The first processing layer handling and processing the received data packets and storage in the queues may be the MAC processing layer or the application processing layer in the multi-layer protocol stack

Via execution of the first processing layer and storage of the received data packets into respective data delivery queues such as associated with the substitute access class configuration 620, the communication management resource 141 associated with the wireless access point 131 processes a first data packet of the multiple data packets and determines that the first data packet includes first data assigned a first transmission priority level. In response to detecting the first data packet includes the first data assigned the first transmission priority level, the communication management resource stores the first data packet in a first queue of multiple queues associated with the substitute access class configuration 620; the first queue is assigned the first transmission priority level. Via processing of a second data packet of the multiple data packets, the communication management resource determines that the second data packet includes second data assigned a second transmission priority level. In response to detecting that the second data packet includes the second data assigned the second transmission priority level, the communication management resource stores the second data packet in a second queue of multiple queues associated with the substitute access class configuration 620. The second queue is assigned the second transmission priority level. In a similar manner as previously discussed, a respective data packet scheduling manager transmits the data packets depending on the queues in which the data packets are stored.

Thus, implementation of a substitute access class configuration 620 via agreement between the wireless stations (such as between the wireless access point 131 and the communication device 121) as discussed herein enables expansion of classes with respect to the original default access class configuration 610.

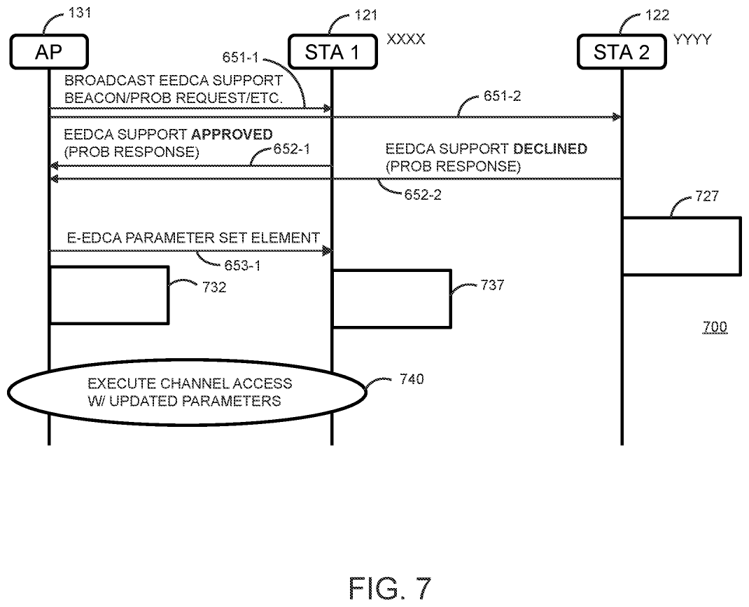

FIG. 7 is an example diagram illustrating customization of data delivery classes amongst multiple wireless stations as discussed herein.

In one example, the communication system including the wireless access point 131, mobile communication device 121, mobile communication device 122, etc., as discussed herein supports conveyance of capability exchange communications (651, 652) between the wireless access point 131 and the communication devices 121 and 122. The capability exchange communications can happen any time such as: i) during association of the communication device 121 to the wireless access point 131, ii) via a probe request/probe response frames where the wireless access point 131 and the communication device 121 exchange support information associated with the dynamic (custom) data delivery mode as discussed herein, etc.

Note further that the capability exchange communications 651 and 652 can include any information indicating that the wireless station (wireless access point 131, communication device 121, or communication device 122) sending such information supports a customized implementation of multiple access classes and corresponding data delivery queues (such as supported by the custom access class configuration 620) with respect to a default implementation of multiple access classes and corresponding data delivery queues (such as supported by the default access class configuration 610).

In one example, if either or both the wireless access point 131 and the communication device 121 support the custom data delivery mode such as supporting customization as discussed herein, then either or both of the wireless access point 131 and the communication device 121 can be reconfigured to support the selected customized data delivery mode supporting different levels of data conveyance services as previously discussed.

Conversely, assume that the wireless access point 131 and the communication device 122 do not support or do not wish to implement the custom data delivery mode. In such an instance, the wireless access point 131 and the communication device 122 both are configured to implement the conventional technique of using the default implementation of multiple access classes and corresponding data delivery queues (such as supported by the default access class configuration 610) to convey data packets between the wireless access point 131 and the communication device 122.

In another example, the default access class implementation of the corresponding default EDCA (Enhanced Distributed Channel Access) mode associated with multiple wireless stations can be customized based upon the needs of the corresponding communicating wireless stations. Adjustments or modifications to the original default implementation may include conveyance of a so-called customization Parameter Set element (i.e., a communication) from one wireless station to another to provide information needed by stations for proper operation of the QoS (Quality of Service) facility.

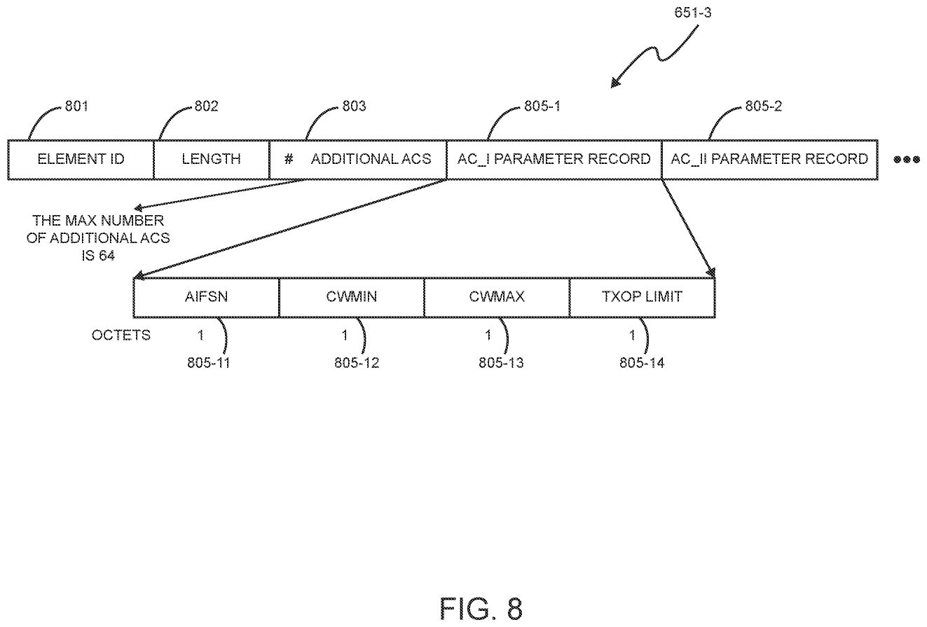

Subsequently, an E-EDCA Parameter Set element (communications such as in FIG. 8) may be exchanged between the wireless access point 131 and the wireless station 121 via a so-called Management frame, which includes all the necessary parameters (e.g. CWmin, CWmax, AIFSN, and TXOP limit) to support the extra one or more data delivery queues as discussed herein.

Referring again to FIG. 7, note further that the additional data delivery queues (as a result of customization) can be implemented as an alternative to the default data delivery mode as additional classes with respect to standard default access class queues (such as BE, BK, VI, and VO) for channel access and traffic classifications. In such an instance, the wireless access point 131 and the communication device 121 can be configured to support the default access class queues or the customized access class queues based on a selected additional number of access class queues as desired.

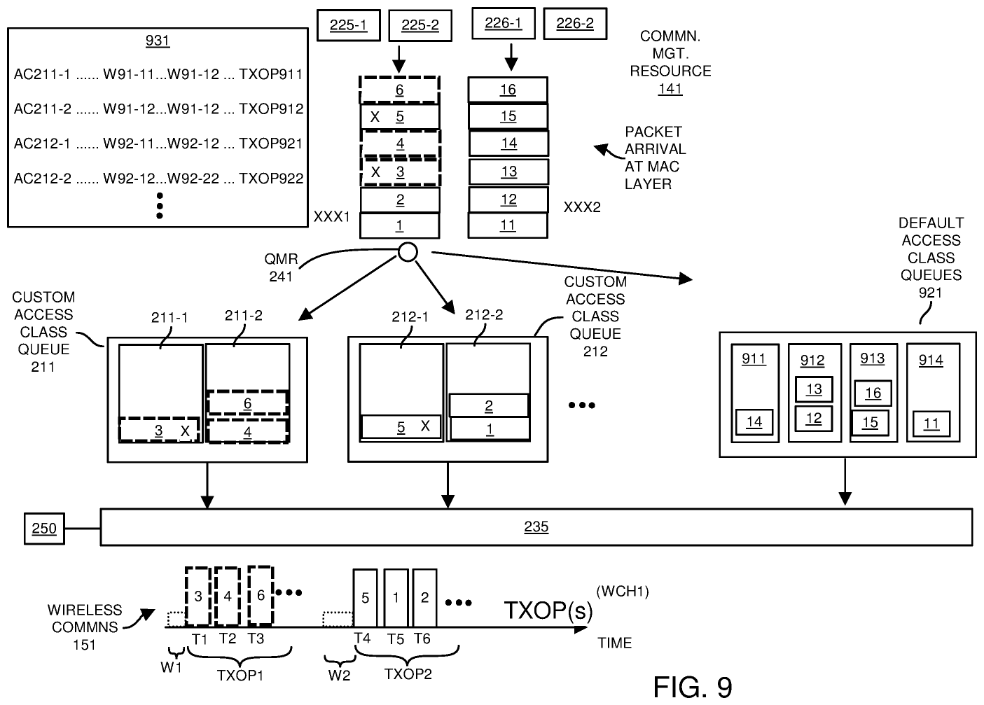

Alternatively, note that the custom set of data delivery queues as specified by the setup communications can be implemented in the extended data delivery mode as additional classes with respect to standard default access class queues (such as BE, BK, VI, and VO) for channel access and traffic classifications. In such an instance, the wireless access point 131 and the communication device 121 can be configured to support the default access class queues and a selected additional number of access class queues as desired. This is further discussed in FIG. 9.

As a more specific example as shown in the timing diagram 700 of FIG. 7, the wireless access point 131 wirelessly transmits the communications 651 (such as communications 651-1 and communications 651-2) to one or more wireless stations in the network environment 100. The communications 651 (such as a broadcast beacon in the presence of the wireless access point 131 in the network environment 100, probe request, configuration request, etc.) include a notification that the wireless access point 131 supports the custom access class configuration mode.

As further shown in FIG. 7, in response to receiving the communications 651-1, the mobile communication device 121 transmits the communications 652-1 to the wireless access point 131. In one example, the communications 652-1 notify the wireless access point 131 that the communication device 121 approves or accepts access class operation in the customized mode.

In response to receiving the communications 651-2, the mobile communication device 122 transmits the communications 652-2 to the wireless access point 131. In one example, the communications 652-2 notify the wireless access point 131 that the communication device 122 disapproves or rejects access class operation in the customized mode. The communication device 122 can be configured to disapproval reject operation of the access classes in the custom mode for any suitable reason. In one example, the communication device 122 not have the ability to be configured to implement the custom mode of access classes. For any communication device receiving the inquiry message such as communication 651 that does not respond to the query with respect to operation the custom mode, the wireless access point 131 can be configured to default to implementation of conveying communications in accordance with the default access class mode. Accordingly, the system as discussed herein is backwards compatible with legacy systems that do not support the custom access class mode.

When the wireless access point 131 receives notification in communications 652-1 that the first mobile communication device 121 supports the custom mode and the wireless access point 131 receives notification in communications 652-2 that the second communication device 122 does not support the custom mode (or does not wish to implement the custom mode), the wireless access point 131 implements two sets of access class queues—a first set of auxiliary queues (such as additional custom set of queues with respect to default queues) to support the communications between the wireless access point and the first mobile communication device and a second set of queues (default queues) to support communications from the wireless access point 131 to the second mobile communication device 122.

Via operations 727, the wireless station 122 executes the default set of access class queues to support conveyance of a respective subsequent communications in an uplink direction to the wireless access point 131.

If desired, in one example, the communications 652-1 received from the mobile communication device 121 indicate information such as specifics of permitting a customized set of access classes and corresponding queues to support conveyance of wireless communications over the wireless communication link 171. It may be known by the communication device 121 or the wireless access point 131 that the mobile communication device 121 is currently executing multiple different types of applications supporting conveyance of different types of communications (such as voice, video, etc.). Based on such information, the wireless access point 131 and/or the mobile communication device 121 can be configured to establish a custom set of access classes and corresponding queues that support those applications.

Additionally, or alternatively, the wireless access point 131 can be configured to select implementation details associated with the custom access class and corresponding queues to be supported by the mobile communication device 121. In one example, the wireless access point 131 transmits the communications 651-3 to the mobile communication device 121. The communications 651-3 can be configured to indicate custom mode setup information such as number of custom access class queues to be supported in the custom mode as implemented by the mobile communication device 121, contention window information associated with the custom access class queues, TXOP limit information associated with the custom access class, etc.

In response to receiving the communications 651-3, via operations 737, the mobile communication device 121 sets up a custom access class configuration as indicated by the communication 651-3. The mobile communication device 121 uses the custom access classes and corresponding queues as a basis in which to subsequently communicate data packets (such as communications 740) from the mobile communication device 121 over the wireless communication link 171 to the wireless access point 131.

In accordance with further examples as discussed herein, in response to the communication 652-1, via operations 732, the wireless access point 131 can be configured to implement a set of custom access classes and corresponding access class queues to support subsequent communications 740 in the downlink direction from the wireless access point 131 to the mobile communication device 121.

In response to the communications 652-3, the mobile communication device 121 can be configured to implement a set of custom access classes and corresponding access class queues to support subsequent communications 740 in the uplink direction from the mobile communication device to the wireless access point 131.

As further discussed herein, as previously discussed, there may be a case where the wireless access point 131 implements multiple sets of access classes and corresponding access class queues to communicate data packets in the downlink direction to multiple wireless stations including communication device 121 and communication device 122. For example, because the mobile communication device 122 does not support the customization mode, the wireless access point 131 can be configured to allocate storage for traffic to the mobile communication device 122 in the default set of queues. Conversely, the mobile communication device 121 supports the custom access class mode and therefore benefits from finer granularity of quality of service queuing. In such an instance, the wireless access point 131 stores traffic destined for delivery to the communication device 121 in the extended (custom) set of the queues and/or the default set of queues.

Thus, in a first example, the wireless access point 131 can be configured to store data packets destined for delivery to the mobile communication device 121 in the custom access class queues as well as the default access class queues for communication of those data packets to the mobile communication device 121. Alternatively, in a second example, the wireless access point 131 can be configured to store data packets destined for delivery to the mobile communication device 121 only in the custom access class queues and not the default access class queues for communication of those data packets to the mobile communication device 121.

In accordance with further examples, when the wireless access point 131 has data packets for delivery to the first mobile communication device 121 and the second mobile communication device 122, the wireless access point 131 and corresponding schedule or analyzes the data packets destined for the mobile communication device 121 and the mobile communication device 122. The wireless access point 131 looks at the destination address of the respective data packet and determine which set of queues (auxiliary queues or default queues) it is supposed to use in order to transmit those data packets to the corresponding destinations.

It is further noted that the wireless access point 131 supports the capability to manage finer granularity associated with the custom access classes for traffic classification from the outset. For instance, the wireless access point 131 can be equipped with 8 access class queues (such as in FIG. 3) for storing received data packets (i.e., traffic). Additionally, assume that the mobile communication device 121 supports 8 queues while the communication device 122 is limited to supporting only the default 4 queues. When receiving a MSDU from the higher layers, the wireless access point 131 identifies a corresponding destination address to which the data packet is being transmitted. Depending on whether the intended recipient as indicated by the corresponding destination address supports 8 or 4 queues, the wireless access point 131 allocates storage in the respective different queues for DL traffic accordingly.

As further discussed herein, note that to avoid potential unfairness of transmitting data packets from the wireless access point 131 to the communication devices 121 and 122, the techniques herein can be configured to include constraining the channel access parameters, such as CWmin, CWmax, and AIFS (a.k.a., Arbitration Interframe Space Number) associated with the custom access classes and corresponding access class queues to be between the minimum and maximum values of the default parameters supported by legacy default access classes and corresponding access class queues. In such an instance, implementation of the custom access classes and corresponding access class queues is not detrimental to the simultaneous implementation of the default access classes and corresponding asset class queues.

In a further example, the recipient such as wireless access point 131 or communication device 121 doesn't need to do anything to receive the data packets destined for it regardless of which mode (default mode or custom mode) is used to transmit the corresponding communications from the communication device or the wireless access point.

FIG. 8 is an example diagram illustrating a configuration management frame supporting customization of data delivery classes as discussed herein.

In one example, the communication 651-3 communicated from the wireless access point 131 (such as first wireless station) to the mobile communication device 121 (such as the second wireless station) includes one or more data fields of information, which is a variable length element (communication) depending on the number of additional access classes and corresponding access class queues that are going to be established to support downlink communications from the wireless access point 131 to the mobile communication device 121. In a further example, note that the communication 651-3 and/or corresponding data fields as shown in FIG. 8 can be transmitted via any management frame after extended capability exchange as indicated by the communications 651-1 and/or communication 652-1.

Further in this example, the data field 801 stores an element identifier indicating the variable length management frame such as communication 651-3. Data field 802 indicates corresponding length of the communication 651-3. Data field 803 indicates the number of access classes and corresponding access class queues that are going to be set up by the communication device 121 to support uplink communications from the communication device 121 to the wireless access point 131 using the custom mode as discussed herein.

Further in this example, each of the data fields 805 indicates attributes associated with the custom access class queues to be supported by the communication device 121.

For example, data field 805-11 indicates an arbitration interframe space number (such as any suitable integer value between 2 and 7 or other suitable value/s) associated with a first access class queue to be supported by the mobile communication device 121; data field 805-12 indicates the lower limit of a contention window (such as greater than 7) associated with the first access class queue; data field 805-13 indicates the upper limit of a contention window associated with the first access class queue; data field 805-14 indicates the maximum airtime occupancy during the corresponding access channel associated with the first access class queue.

In a similar manner, each of the data fields 805-2, etc., include similar types configuration information associated with the second access class queue as indicated by the data field 803. Note that the configuration of each of the access class queues as indicated by the data field 803 varies depending upon the settings associated with the data field 805-1, data field 805-2, etc.

FIG. 9 is an example diagram illustrating implementation of multiple custom access class queues and default access class queues as discussed herein.

As previously discussed, the wireless access point 131 and corresponding mobile communication device 121 can be configured to support custom access class queues 211, 212, etc., as well as default access class queues 921.

Assume in this example that the custom access class queues (potentially established for the mobile communication device 121 in response to receiving the communications 652-1) support communication of respective data packets from the wireless access point 131 to the mobile communication device 121 assigned the network address XXX1.

The default access class queues 921 support communication of respective data packets from the wireless access point 131 to the mobile communication device 122 assigned the network address XXX2. As discussed herein, the custom access class queues provide better and/or higher resolution quality of service then the default access class queues.

In this example, the applications 225 (one or more different applications such as application 225-1 such as a voice data processing application, application 225-2 such as a video processing application, and so on) generate data packets 1, 2, 3, 4, 5, 6, etc., for transmission to the mobile communication device 121 assigned the network address XXX1. Each of the data packets 1, 2, 3, 4, 5, 6, etc., include a respective destination network address of XXX1 to ensure delivery of the data packets to the indication device 121. Note that the different applications such as application 225-1, application 225-2, etc., can be located anywhere in the network 190.

Further in this example, the applications 226 (one or more different applications such as application 226-1, application 226-2, etc.) generate data packets 11, 12, 13, 14, 15, 16, etc., for transmission to the mobile communication device 122 assigned the network address XXX2. Each of the data packets 11, 12, 13, 14, 15, 16, etc., include a respective destination network address of XXX2 to ensure delivery of the data packets communication device 122. Note that the different applications such as application 226-1, application 226-2, etc., can be located anywhere in the network 190.

The queue management resource 241 associated with the communication management resource 141 of the wireless access point 131 in this example sorts the different received data packets into the different access class queues depending upon the corresponding destination network address of the received data packets. For example, based on processing of the data packets, the queue management resource 241 determines that the data packets 11, 12, 13, 14, 15, and 16 each include a destination address of XXX2 and are thus transmitted to the communication device 122. In such an instance, the queue management resource 241 stores these data packets in different queues of the default access queues 921.

As shown, based on corresponding quality of service type as detected from processing the data packet 14, the queue management resource 141 stores the received data packet 14 in the default access class queue 911 (such as such as supporting voice communications).

Based on corresponding type and quality of service as detected from processing the data packets 12 and 13, the queue management resource 141 stores the received data packets 12 and 13 in the default access class queue 912 (such as such as supporting video communications).

Based on corresponding type and quality of services detected from processing the data packets 15 and 16, the queue management resource 141 stores the received data packets 15 and 16 in the default access class queue 913 (such as such as supporting background communications).

Based on corresponding type associated with the data packet 11, the queue management resource 141 stores the received data packet 11 in the default access class queue 914 (such as such as supporting best efforts communications).

In accordance with conventional default access class configurations, the scheduling management resource 235 acquires the respective wireless channel via the listen before talk function. Subsequent to acquiring the respective wireless channel, the scheduling management resource 235 and corresponding wireless access point 131 transmit the respective data packets in the default access class queues 921 to the mobile communication device 122.

Additionally, the queue management resource 241 determines that the data packets 1, 2, 3, 4, 5, and 6 each include a destination network address XXX1 and are thus transmitted to the communication device 122. In a manner as previously discussed in FIG. 2 and corresponding description, the wireless access point 131 stores the data packets in the custom access class queues and sub queues for transmission of the corresponding data packets 1, 2, 3, 4, 5, and 6 to the communication device assigned the network address XXX1.

Accordingly, as previously discussed in FIG. 2, first data packets such as data packets 1, 2, 3, 4, 5, and 6, destined for delivery to the first mobile communication device 121 are stored in the custom queues and sub-queues and are later transmitted from the wireless access point 131 to the first mobile communication device 121 depending on a respective priority associated with the custom access class queues and corresponding sub queues. Also, as previously discussed, second data packets such as data packets 11, 12, 13, 14, 15, and 16, destined for delivery to the second mobile communication device 122 are stored in the default queues 921 and are later transmitted from the wireless access point to the second communication device 122.

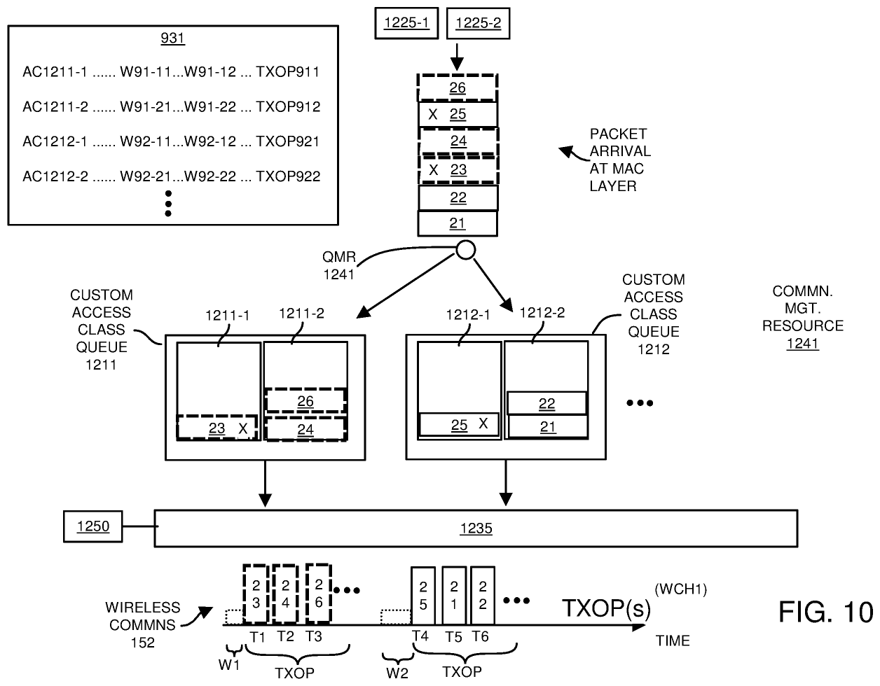

FIG. 10 is an example diagram illustrating implementation of custom access class queues as an alternative to using default access class queues to communicate data packets from a mobile communication device to a wireless access point as discussed herein.

In one example, the communication device 121 executes the communication management resource 1241 as shown in FIG. 10.

In accordance with the communications 651-3 (FIG. 7) such as configuration information as transmitted from the wireless access point 131 to the communication device 121, the communication management resource 1241 of the mobile communication device 121 establishes the respective custom access class queues 1211, 1212, etc., to communicate respective data packets 21, 22, 23, 24, 25, 26, etc., over the wireless communication link 171 from the communication device 121 to the wireless access point 131. Recall that the communication 651-3 indicate how to set up the corresponding custom access class queues at the communication device 121.

Note further that as an alternative to receiving the corresponding communications 651-3 (as discussed in FIG. 7), the communication management resource 1241 can be configured to receive configuration information 931 associated with implementation of the different custom access class queues from any suitable entity.

In this example, assume that the information such as received in the data field 805-1 from the wireless access point 131 indicates attributes of the corresponding custom access class queue 1211 (sub access class AC1211-1 and sub access class AC1211-2) implemented by the communication management resource 1241.

For example, data field 805-11 indicates an arbitration interframe space number (such as any suitable integer value between 2 and 7 or other suitable value/s) associated with implementing the queue 1211 or corresponding sub queues 1211-1 and 1211-2; data field 805-12 indicates the lower limits of contention windows (such as W91-11 for sub queue 1211-1 and W91-21 for sub queue 1211-2) associated with the first access class queue 1211; data field 805-13 indicates the upper limits of contention windows (such as W91-12 for sub queue 1211-1 and W91-22 for sub queue 1211-2) associated with the first access class queue 1211; data field 805-13 indicates the TXOP time limits (such as TXOP911 for sub queue 1211-1 and TXOP912 for sub queue 1211-2).

In a similar manner, assume that the information such as received in the data field 805-2 from the wireless access point 131 indicates attributes of the corresponding custom access class queue 1212 (access class AC1212-1 and AC1212-2) implemented by the communication management resource 1241. For example, a first sub data field of the data field 805-2 indicates an arbitration interframe space number (such as any suitable integer value between 2 and 7 or other suitable value/s) associated with implementing the queue 1212; a second sub data field of the data field 805-2 indicates the lower limits of contention windows (such as W92-11 for sub queue 1212-1 and W92-21 for sub queue 1212-2) associated with the access class queue 1212; a third sub data field of the data field 805-2 indicates the upper limits of contention windows (such as W92-12 for sub queue 1212-1 and W92-22 for sub queue 1212-2) associated with the access class queue 1212; a fourth sub data field of the data field 805-2 indicates the TXOP time limits (such as TXOP921 for sub queue 1212-1 and TXOP922 for sub queue 1212-2).

In one example, the information associated with the different custom access class queues (as indicated by the communications 651-3) is shown in FIG. 10 as configuration information 931.

In this example, assume that the communication device 121 executes the corresponding application 1225-1 and the application 1225-2. One or more of these applications generates corresponding data packets for processing at the MAC layer or other suitable layer by the queue management resource 1241. Each of the data packets received by the queue management resource 1241 is destined for delivery through the wireless access point 131 to a corresponding destination address as indicated by each respective data packet.

As shown, the queue management resource 1241 processes each of the received data packets 21-26 and stores them in a respective custom access class queue depending on the type of data being transmitted.

More specifically, in response to determining that the data packet 21 is associated with the quality of service corresponding to the custom access class queue 1212-2, the queue management resource 1241 stores the data packet 21 in the sub queue 1212-2 for delivery to the wireless access point 131.

In response to determining that the data packet 22 is associated with the quality of service corresponding to the custom access class queue 1212-2, the queue management resource 1241 stores the data packet 22 in the sub queue 1212-2 for subsequent delivery to the wireless access point 131.

In response to determining that the data packet 23 is marked with a low latency tag X and is associated with the quality of service corresponding to the custom access class sub queue 1211-1, the queue management resource 1241 stores the data packet 23 in the sub queue 1211-1 for subsequent delivery to the wireless access point 131.

In response to determining that the data packet 24 is not marked with a low latency tag and is associated with the quality of service corresponding to the custom access class queue 1211-2, the queue management resource 1241 stores the data packet 24 in the sub queue 1211-2 for subsequent delivery to the wireless access point 131.

In response to determining that the data packet 25 is marked with a low latency tag X and is associated with the quality of service corresponding to the custom access class sub queue 1212-1, the queue management resource 1241 stores the data packet 25 in the sub queue 1212-1 for subsequent delivery to the wireless access point 131.

In response to determining that the data packet 26 is not marked with the low latency tag and is associated with the quality of service corresponding to the custom access class sub queue 1211-2, the queue management resource 1241 stores the data packet 26 in the sub queue 1211-2 for subsequent delivery to the wireless access point 131.

In a similar manner as previously discussed, the communication management resource 1241 includes a respective data packet scheduling manager 1235 to schedule transmission of the corresponding data packets in the custom access class queues over the acquired wireless channel WCH1 for delivery over the wireless communication link 171 to the wireless access point 131.

In one example, the data packet scheduling manager 1235 implements the rules 1250 and settings as specified by the configuration information 931 to transmit the respective data packets in the custom access class queues over the wireless communication link 171. In other words, the communication management resource 441 first acquires the wireless channel WCH1 one or more times and then transmits the respective data packets stored in the queues in accordance with a priority associated with each of the custom access class queues and sub queues.

For example, the sub queue 1211-1 is assigned the highest priority amongst the custom queues. Accordingly, the scheduling management resource first transmits the data packet 23 followed by transmitting data packet 24 and data packet 26 from the second highest priority sub queue 1211-2 over the acquired wireless channel WCH1 to the wireless access point 131 in one or more TXOPs.

The sub queue 1212-1 is assigned the third highest priority amongst the custom queues. Accordingly, after transmitting the data packets in the custom access class queue 1211, the scheduling management resource transmits the data packet 25 from the third highest priority sub queue followed by transmitting data packet 21 and data packet 22 from the fourth highest priority sub queue 1212-2 over the acquired wireless channel WCH1 to the wireless access point 131 in one or more TXOPs.

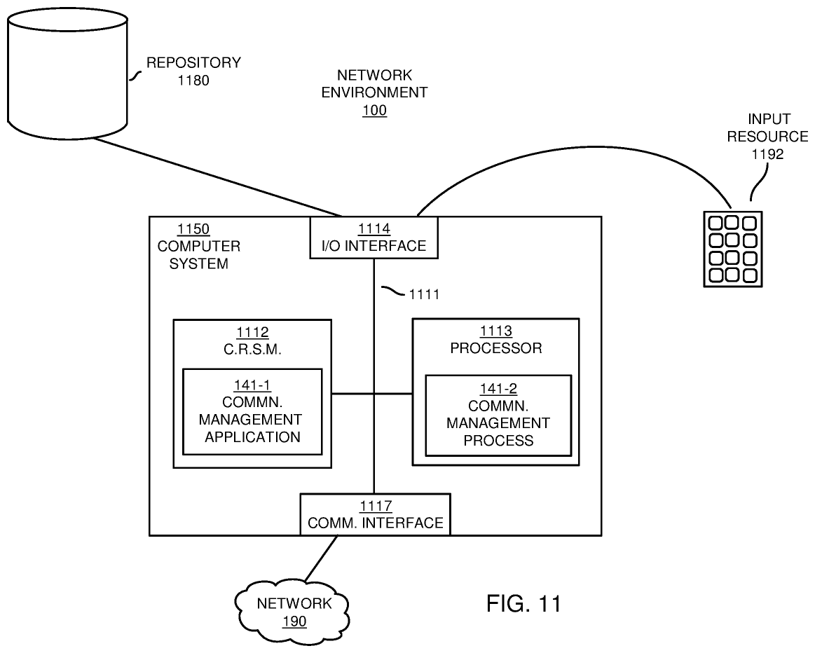

FIG. 11 is an example block diagram of a computer system for implementing any of the operations as previously discussed according to examples herein.

Any of the resources (such as wireless stations, communication management resource 141, communication management resource 1241, wireless access point 131, mobile communication device 121, etc.) as discussed herein can be configured to include computer processor hardware and/or corresponding executable instructions to carry out the different operations as discussed herein via computer system 1150.

As shown, computer system 1150 of the present example includes an interconnect 1111 coupling computer readable storage media 1112 such as a non-transitory type of media (or more generally, computer readable hardware which can be any suitable type of hardware storage medium in which digital information can be stored and retrieved), a processor 1113 (computer processor hardware), I/O interface 1114, and a communications interface 1117.

I/O interface(s) 1114 supports connectivity to repository 1180 and input resource 1192.

Computer readable storage medium 1112 (such as computer readable hardware or other suitable entity) can be any hardware storage device such as memory, optical storage, hard drive, floppy disk, etc. In one example, the computer readable storage medium 1112 stores instructions and/or data.

As shown, computer readable storage media 1112 can be encoded with management application 140-1 (e.g., including instructions) to carry out any of the operations as discussed herein.

During operation of one example, processor 1113 accesses computer readable storage media 1112 via the use of interconnect 1111 in order to launch, run, execute, interpret or otherwise perform the instructions in management application 140-1 stored on computer readable storage medium 1112. Execution of the management application 140-1 produces management process 140-2 to carry out any of the operations and/or processes as discussed herein.

Those skilled in the art will understand that the computer system 1150 can include other processes and/or software and hardware components, such as an operating system that controls allocation and use of hardware resources to execute management application 140-1.

In accordance with different examples, note that computer system may reside in any of various types of devices, including, but not limited to, a mobile computer, a personal computer system, wireless station, connection management resource, a wireless device, a wireless access point, a base station, phone device, desktop computer, laptop, notebook, netbook computer, mainframe computer system, handheld computer, workstation, network computer, application server, storage device, a consumer electronics device such as a camera, camcorder, set top box, mobile device, video game console, handheld video game device, a peripheral device such as a switch, modem, router, set-top box, content management device, handheld remote control device, any type of computing or electronic device, etc. The computer system 1150 may reside at any location or can be included in any suitable resource in any network environment to implement functionality as discussed herein. In one example, the control system 1150 can include or be implemented in virtualization environments such as the cloud.

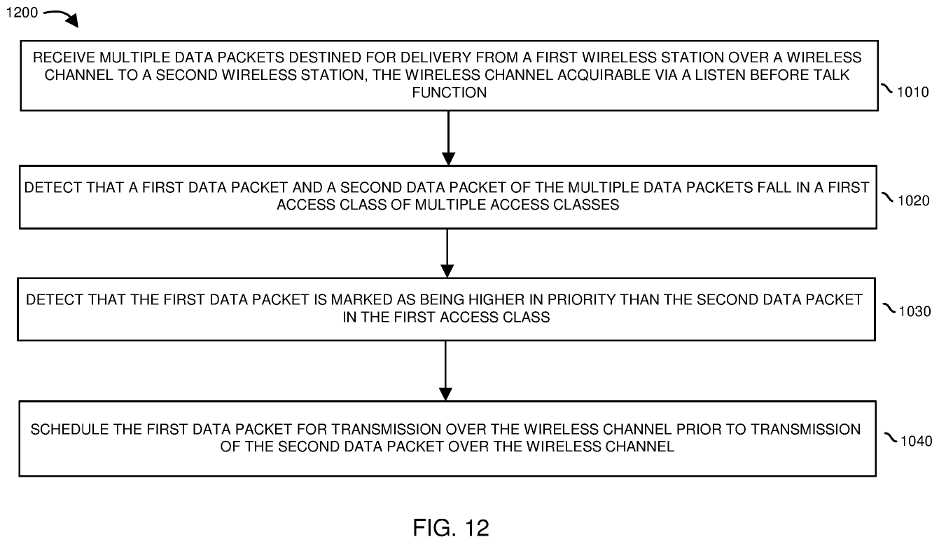

Functionality supported by the different resources will now be discussed via flowchart in FIGS. 12-15. Note that the steps in the flowcharts below can be executed in any suitable order.

FIG. 12 is a flowchart 1200 illustrating an example method according to examples. Note that flowchart 1200 overlaps/captures general concepts as discussed herein.

In processing operation 1210, the communication management resource 141 of the wireless access point 131 (first wireless station) receives multiple data packets destined for delivery from the first wireless station over a wireless channel WCH1 to a second wireless station (mobile communication device 121). As previously discussed, the wireless channel WCH1 is acquirable via a listen before talk function (a.k.a., clear channel assessment).

In processing operation 1220, the communication management resource 141 of the wireless access point 131 detects that a first data packet and a second data packet of the multiple data packets fall in a first access class of multiple access classes.

In processing operation 1230, the communication management resource 141 further detects that the first data packet is marked as being higher in priority than the second data packet in the first access class.

In processing operation 1240, via storage in the different queues, the communication management resource 141 schedules the first data packet for transmission over the wireless channel prior to transmission of the second data packet over the wireless channel WCH1.

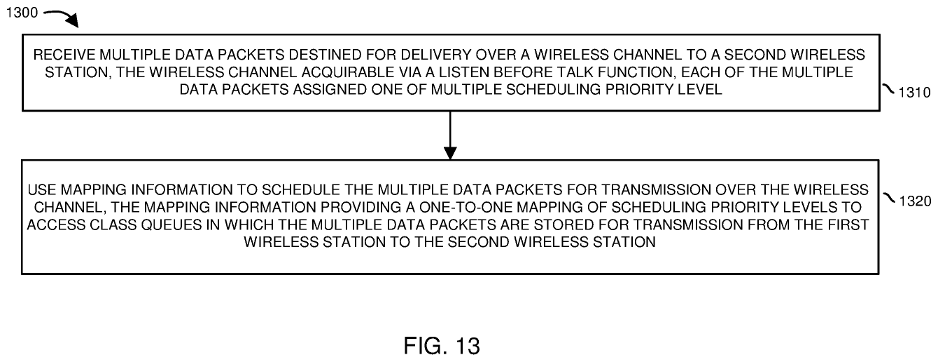

FIG. 13 is a flowchart 1300 illustrating an example method according to examples. Note that flowchart 1300 overlaps/captures general concepts as discussed herein.

In processing operation 1310, the communication management resource 141 of the first wireless station (wireless access point 131) receives multiple data packets destined for delivery over a wireless channel WCH1 (and wireless communication link) to a second wireless station (such as mobile communication device 121). The wireless channel WCH1 is acquirable via a listen before talk function. Each of the multiple data packets is assigned one of multiple scheduling priority levels.

In processing operation 1320, the communication management resource 141 uses mapping information to schedule the multiple data packets for transmission over the wireless channel WCH1 and corresponding wireless communication link. The mapping information proves a one-to-one mapping of scheduling priority levels to access class queues in which the multiple data packets are stored for transmission from the first wireless station to the second wireless station.

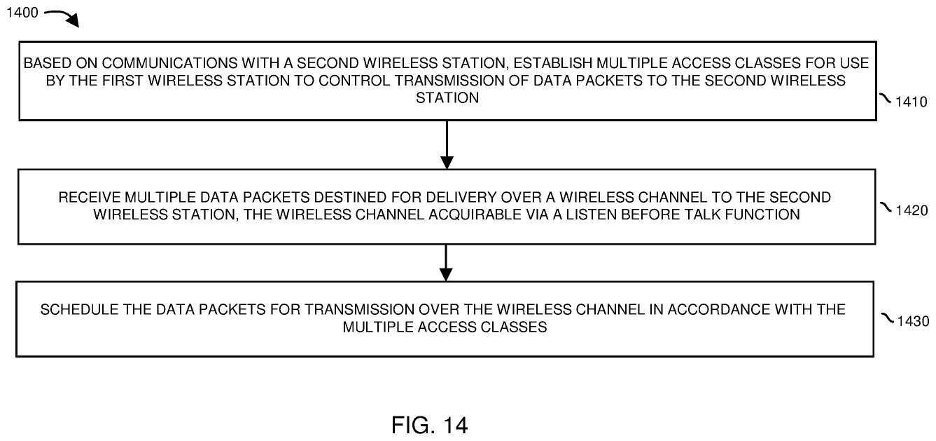

FIG. 14 is a flowchart 1400 illustrating an example method according to examples. Note that flowchart 1000 overlaps/captures general concepts as discussed herein.

In processing operation 1410, based on communications with a second wireless station, the communication management resource 141 of the first wireless station such as wireless access point 131 establishes multiple access classes for use by the first wireless station to control transmission of data packets to the second wireless station such as mobile communication device 121.

In processing operation 1420, the communication management resource 141 receives multiple data packets destined for delivery over a wireless channel WCH1 to the second wireless station. In a manner as previously discussed, the wireless channel WCH1 is acquirable via a listen before talk function.

In processing operation 1430, the communication management resource 141 schedules the received data packets for transmission over the wireless channel WCH1 in accordance with the multiple access classes for subsequent transmission to the mobile communication device 121.

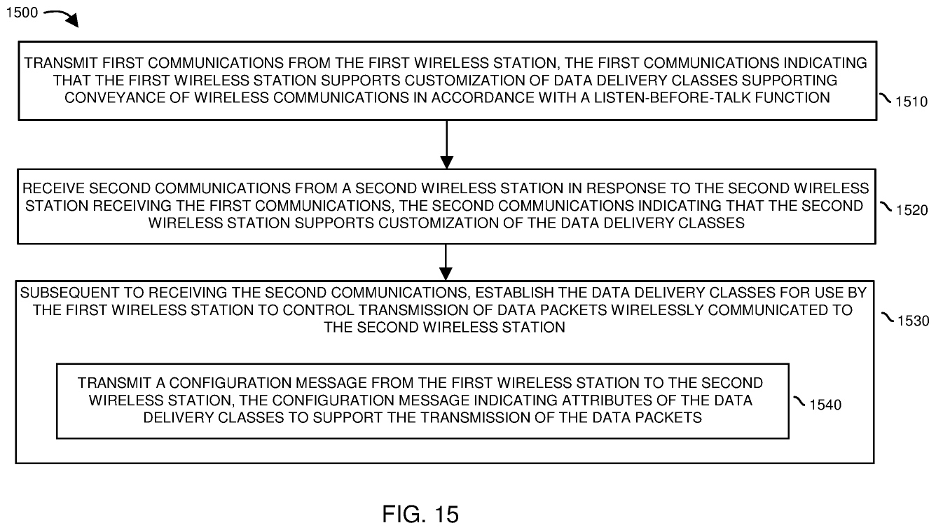

FIG. 15 is a flowchart 1500 illustrating an example method according to examples. Note that flowchart 1500 overlaps/captures general concepts as discussed herein. In In processing operation 1510, a first wireless station transmits first communications indicating that the first wireless station supports customization of data delivery classes supporting conveyance of wireless communications in accordance with a listen-before-talk function.

In processing operation 1520, the first wireless station receives second communications from a second wireless station in response to the second wireless station receiving the first communications. The second communications indicate that the second wireless station supports the customization of the data delivery classes. As further discussed herein, the first wireless station of the second wireless station configured themselves to support the customization of the data delivery classes as negotiated by 3 occasions between the first wireless station and the second wireless station.

Note again that techniques herein are well suited to facilitate more efficient operation of providing quality of service in a clear channel assessment communication system. However, it should be noted that examples herein are not limited to use in such applications and that the techniques discussed herein are well suited for other applications as well.

Based on the description set forth herein, numerous specific details have been set forth to provide a thorough understanding of claimed subject matter. However, it will be understood by those skilled in the art that claimed subject matter may be practiced without these specific details. In other instances, methods, apparatuses, systems, etc., that would be known by one of ordinary skill have not been described in detail so as not to obscure claimed subject matter. Some portions of the detailed description have been presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm as described herein, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has been convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

While this invention has been particularly shown and described with references to preferred examples thereof, it will be understood by those skilled in the art that various changes in form and details may be made therein without departing from the spirit and scope of the present application as defined by the appended claims. Such variations are intended to be covered by the scope of this present application. As such, the foregoing description of examples of the present application is not intended to be limiting. Rather, any limitations to the invention are presented in the following claims.

We claim:

1. A method comprising:
at a first wireless station implementing a listen before talk function to communicate over a wireless channel to a second wireless station:
receiving multiple data packets destined for delivery over the wireless channel to the second wireless station;
detecting that a first data packet and a second data packet of the multiple data packets fall in a first access class of multiple access classes;
detecting that the first data packet is marked as being higher in priority than the second data packet in the first access class; and
scheduling the first data packet for transmission over the wireless channel prior to transmission of the second data packet over the wireless channel.

2. The method as in claim 1 further comprising:
at the first wireless station:
mapping an identity of the first access class to a first clear channel assessment window assigned to the first access class; and
in response to detecting non-use of the wireless channel for a time duration as specified by the first clear channel assessment window: transmitting the first data packet over the wireless channel followed by transmission of the second data packet over the wireless channel.

3. The method as in claim 1 further comprising:
via the first wireless station:
transmitting the first data packet over the wireless channel in response to a first acquisition of the wireless channel; and
transmitting the second data packet over the wireless channel in response to a second acquisition of the wireless channel.

4. The method as in claim 1, wherein detecting that the first data packet is marked as being higher in priority than the second data packet in the first access class includes:
based on analyzing first bit information in the first data packet, detecting that the first data packet is marked as a high priority data packet in the first access class; and
based on analyzing second bit information in the second data packet, detecting that the second data packet is not marked as a high priority data packet in the first access class.

5. The method as in claim 1, wherein scheduling the first data packet for transmission over the wireless channel prior to transmission of the second data packet over the wireless channel includes:
storing the first data packet in a first queue of the first access class; and
storing the second data packet in a second queue of the first access class.

6. The method as in claim 5 further comprising:
storing a third data packet in the first queue prior to storing the first data packet in the first queue; and
in accordance with the scheduling: transmitting the third data packet over the wireless channel followed by transmission of the first data packet over the wireless channel before transmitting the second data packet over the wireless channel.

7. The method as in claim 5 further comprising:
in accordance with the scheduling: emptying the first queue by transmitting all data packets in the first queue including the first data packet over the wireless channel before transmitting the second data packet over the wireless channel.

8. The method as in claim 1 further comprising:
implementing a first processing layer to detect that the first data packet is marked as being higher in priority than the second data packet in the first access class, the first processing layer controlling which of multiple queues associated with the first access class each of the first data packet and the second data packet is stored for subsequent transmission over the wireless channel.

9. The method as in claim 1 further comprising:
implementing a first processing layer to process bit information in each of the multiple data packets; and
via the first processing layer: i) storing the first data packet in a first queue associated with the first access class in response to detecting presence of a high priority marker in the first data packet, and ii) storing the second data packet in a second queue associated with the first access class in response to detecting absence of the high priority marker in the second data packet.

10. The method as in claim 1, wherein the multiple data packets received by the first wireless station further include a third data packet and a fourth data packet, the method further comprising:
at the first wireless station:
detecting that the third data packet and the fourth data packet of the multiple data packets fall in a second access class of the multiple access classes; and
scheduling the third data packet and the fourth data packet for transmission over the wireless channel prior to transmission of the first data packet over the wireless channel.

11. The method as in claim 10, wherein scheduling the third data packet and the fourth data packet for transmission over the wireless channel prior to transmission of the first data packet over the wireless channel includes:
storing the third data packet and the fourth data packet in a first queue of the second access class; and
transmitting the third data packet and the fourth data packet over the wireless channel prior to transmitting the first data packet over the wireless channel.

12. The method as in claim 10, wherein scheduling the third data packet and the fourth data packet for transmission over the wireless channel prior to transmission of the first data packet over the wireless channel includes:
storing the third data packet in a first queue of the second access class;
storing the fourth data packet in a second queue of the second access class; and
transmitting the third data packet and the fourth data packet over the wireless channel prior to transmitting the first data packet and the second data packet over the wireless channel.

13. A system comprising:
a communication management resource operative to:
receive multiple data packets destined for delivery from a first wireless station over a wireless channel to a second wireless station, the wireless channel acquirable via a listen before talk function;
detect that a first data packet and a second data packet of the multiple data packets fall in a first access class of multiple access classes;
detect that the first data packet is marked as being higher in priority than the second data packet in the first access class; and
schedule the first data packet for transmission over the wireless channel prior to transmission of the second data packet over the wireless channel.

14. The system as in claim 13, wherein the communication management hardware is further operative to:
map an identity of the first access class to a first clear channel assessment window assigned to the first access class; and
in response to detecting non-use of the wireless channel for a time duration as specified by the first clear channel assessment window: transmit the first data packet over the wireless channel followed by transmission of the second data packet over the wireless channel.

15. The system as in claim 13, wherein the communication management hardware is further operative to:
in accordance with priority associated with the first access class: i) transmit the first data packet over the wireless channel in response to a first acquisition of the first wireless channel, and ii) transmit the second data packet over the wireless channel in response to a second acquisition of the first wireless channel.

16. The system as in claim 13, wherein the communication management hardware is further operative to:
based on analysis of first bit information in the first data packet, detect that the first data packet is marked as a high priority data packet in the first access class; and
based on analysis of second bit information in the second data packet, detecting that the second data packet is not marked as a high priority data packet in the first access class.

17. The system as in claim 13, wherein the communication management hardware is further operative to:
store the first data packet in a first queue of the first access class; and
store the second data packet a second queue of the first access class.

18. The system as in claim 17, wherein the communication management hardware is further operative to:
store a third data packet in the first queue prior to storing the first data packet in the first queue; and
in accordance with the scheduling: transmit the third data packet over the wireless channel followed by transmission of the first data packet over the wireless channel before transmitting the second data packet over the wireless channel.

19. The system as in claim 17, wherein the communication management hardware is further operative to:
in accordance with the scheduling: empty the first queue by transmitting all data packets in the first queue including the first data packet prior to transmitting the second data packet over the wireless channel.

20. The system as in claim 13, wherein the communication management hardware is further operative to:
implement a first processing layer to detect that the first data packet is marked as being higher in priority than the second data packet in the first access class, the first processing layer controlling which of multiple queues associated with the first access class each of the first data packet and the second data packet is stored for subsequent transmission over the wireless channel.

21. The system as in claim 13, wherein the communication management hardware is further operative to:
implement a first processing layer to process bit information in each of the multiple data packets; and
via the first processing layer: i) store the first data packet in a first queue associated with the first access class in response to detecting presence of a high priority marker in the first data packet, and ii) store the second data packet in a second queue associated with the first access class in response to detecting absence of a high priority marker in the second data packet.

22. The system as in claim 13, wherein the communication management hardware is further operative to:
detect that the third data packet and the fourth data packet of the multiple data packets fall in a second access class of the multiple access classes; and
schedule the third data packet and the fourth data packet for transmission over the wireless channel prior to transmission of the first data packet over the wireless channel.

23. The system as in claim 22, wherein the communication management hardware is further operative to:
store the third data packet and the fourth data packet in a first queue of the second access class; and
transmit the third data packet and the fourth data packet over the wireless channel prior to transmitting the first data packet over the wireless channel.

24. The system as in claim 22, wherein the communication management hardware is further operative to:
store the third data packet in a first queue of the second access class;
store the fourth data packet in a second queue of the second access class; and
transmit the third data packet and the fourth data packet over the wireless channel prior to transmitting the first data packet and the second data packet over the wireless channel.

25. Computer-readable storage hardware having instructions stored thereon, the instructions, when carried out by computer processor hardware, cause the computer processor hardware to:
receive multiple data packets destined for delivery from a first wireless station over a wireless channel to a second wireless station, the wireless channel acquirable via a listen before talk function;
detect that a first data packet and a second data packet of the multiple data packets fall in a first access class of multiple access classes;
detect that the first data packet is marked as being higher in priority than the second data packet in the first access class; and
schedule the first data packet for transmission over the wireless channel prior to transmission of the second data packet over the wireless channel.

26. The method as in claim 1 further comprising:
receiving a third data packet of the multiple data packets;
based on analyzing third bit information in the third data packet of the multiple received data packets, detecting that the third data packet is not marked as being a higher priority data packet in the first access class; and
in response to detecting congestion associated with wirelessly transmitting data packets over the wireless channel: i) marking the third data packet with a marker indicating the third data packet as being higher priority in the first access class; and ii) storing the third data packet in a higher priority queue associated with the first access class than would otherwise occur without the marker.
